(19) United States
(12) Patent Application Publication
(10) Pub. No.: US 2006/0287062 A1
(43) Pub. Date: Dec. 21, 2006

(54) Gaming machine

(75) Inventor: Kazuo Okada, Tokyo (JP)

Correspondence Address: ARENT FOX PLLC, 1050 CONNECTICUT AVENUE, N.W., SUITE 400, WASHINGTON, DC, 20036, US

(73) Assignee: ARUZE Corp.

(21) Appl. No.: 11/440,355

(22) Filed: May 25, 2006

(30) Foreign Application Priority Data
May 27, 2005 (JP) 2005-155838
May 27, 2005 (JP) 2005-155839
May 27, 2005 (JP) 2005-155840

(51) Int. Cl. A63F 13/00

(52) U.S. Cl. 463/20

(57) ABSTRACT

A gaming machine that can provide a big fun to the player is provided. The gaming machine comprises: a bet input device for setting a bet number to start a game; a display device for variably displaying a plurality of symbols, wherein the plurality of symbols come to a halt and appear in a stationary manner on the display device such that a value corresponding to a winning combination and the bet number is paid out when the winning combination is included in the appearing plurality of symbols; and a payout device for paying out the value. The bet number is increased according to a lottery result of an additional bet lottery being conducted during a period until the plurality of symbols come to a halt. The payout device pays out the value corresponding to the winning combination and the increased bet number.

### CROSS REFERENCE TO RELATED APPLICATIONS

This application is based upon and claims the benefits of priorities from Japanese Patent Application Nos. 2005-155838, 2005-155839 and 2005-155840 filed on May 27, 2005, the entire contents of which are incorporated herein by reference.

### FIELD OF THE INVENTION

The present invention relates to a gaming machine such as a pachi-slot machine and a slot machine.

### RELATED ART

With a gaming machine such as a pachi-slot machine, a medal is inserted or an equivalent value to the medal having been previously inserted and stored is consumed as a BET button is pressed for each game to be played. In such a gaming machine, a player himself decides the number of bets (or amount of wagers) to play the game. However, each player enjoys the game in different ways so that some always bet the maximum amount (MAX bets) to play the game, and some always bet a single medal (or coin) to play the game and their ways of enjoying the game are extremes. Therefore, if only the player can decide the number of bets, some players who bet only one medal (or coin) may not enjoy a peculiar effect for the MAX bets, which is provided by the game designer, or a feeling of obtaining a large number of medals due to the different payout rate at the MAX bets.

On the other hand, the player who plays the game with the MAX bets tends to buy a predetermined number of medals when the player realizes that he has some deposited medals, but not enough number of medals such that he could not continue to play a game with the MAX bets even though he wishes to quit if he lost all deposited medals after the next game with the MAX bets. Therefore, the player has to continue to play games consecutively with the MAX bets since it is not likely that exactly the same number of medals for the MAX bets are left for the last game, in which he loses.

Now, a gaming machine in which pay lines hidden in a normal state may emerge according to a lottery has been disclosed (for example, Japanese Unexamined Patent Application Publication No. 2002-233607). According to the Japanese Unexamined Patent Application Publication No. 2002-233607, the player may enjoy a peculiar effect as the pay lines emerge by the lottery and the feeling of obtaining a large number of medals as the number of pay lines is increased. It is also possible to play the last game, in which the player loses, without buying the predetermined number of medals to make up for the deficient number of medals since there is a possibility of obtaining a large number of pay lines without the MAX bets.

Since the number of medals to be paid out to the player differs depending on the bet number in a conventional gaming machine, the player is concerned with the bet number. In other words, the player has some expectation according to the bet number in each game. However, it is difficult for the player to have a certain expectation based on the bet number with the gaming machine disclosed in the Japanese Unexamined Patent Application Publication No. 2002-233607 since the number of bets and the emerging pay lines (if any) are little related with each other.

### SUMMARY OF THE INVENTION

According to the present invention, there is provided a gaming machine that can provide a big fun to the player. The gaming machine comprises: a bet input device for setting a bet number to start a game; a display device for variably displaying a plurality of symbols, wherein the plurality of symbols come to a halt and are displayed in a stationary manner on the display device such that a value corresponding to a winning combination and the bet number is paid out when the winning combination is included in the displayed plurality of symbols; and a payout device for paying out the value. The bet number could be increased according to a lottery result of an additional bet lottery being conducted during a period until the plurality of symbols come to a halt. Then, the payout device eventually pays out the value corresponding to the winning combination and the increased bet number.

Further features of the present invention, its nature, and various advantages will be more apparent from the accompanying drawings and the following description of the preferred embodiment.

### BRIEF DESCRIPTION OF THE DRAWINGS

FIG. 1 is a perspective view showing a general appearance of a slot machine according to a first embodiment.

FIG. 2 is a front view showing variable display parts of the slot machine according to the first embodiment.

FIG. 3 is a front view showing an operation table of the slot machine according to the first embodiment.

FIGS. 4A through 4E show schematically series of symbol arrays of first reel band through fifth reel band, which are displayed variably in the variable display parts.

FIG. 5 is a block diagram showing schematically a control system of the slot machine according to the first embodiment.

FIG. 6 is a block diagram showing a liquid crystal driving circuit of a liquid crystal display.

FIG. 7 shows each storage area of ROM according to the first embodiment.

FIGS. 8A through 8D show examples of payout tables according to the first embodiment.

FIG. 9 shows an example of a high probability shift lottery table.

FIG. 10 shows an example of a high probability end lottery table.

FIG. 11A is a schematic diagram showing reels which have a plurality of symbols being displayed variably and are stopped to cause the plurality of symbols to appear in a stationary manner in the variable display parts in a base game mode.

FIG. 11B is a schematic diagram showing reels which have a plurality of symbols being displayed variably and are stopped to cause the plurality of symbols to appear in a stationary manner in the variable display parts in a high probability mode.

FIG. 12 is a schematic diagram showing a sixth reel band to be displayed variably in the variable display part.

FIGS. 13A and 13B show examples of additional bet lottery tables according to the first embodiment.

FIG. 14 is a flow chart of a main process program of the slot machine according to the first embodiment.

FIG. 15 is a flow chart of a start acceptance process program of the slot machine according to the first embodiment.

FIG. 16 is a flow chart of a lottery process program of the slot machine according to the first embodiment.

FIG. 17 is a flow chart of a base game process program of the slot machine according to the first embodiment.

FIG. 18 is a flow chart of a bet addition process program of the slot machine according to the first embodiment.

FIG. 19 is a flow chart of a high probability mode switching process program of the slot machine according to the first embodiment.

FIG. 20 is a flow chart of a bonus game process program of the slot machine according to the first embodiment.

FIGS. 21A and 21B are front views displayed on a lower liquid crystal display after the reels are stopped.

FIG. 22 shows an example of a payout table according to a second embodiment.

FIG. 23 shows an example of an additional bet lottery table according to the second embodiment.

FIG. 24A is a flow chart of a bet addition process program of the slot machine according to the second embodiment.

FIG. 24B is a flow chart of another kind of bet addition process program of the slot machine according to the second embodiment.

FIGS. 25A through 25C show examples of additional bet lottery tables according to a third embodiment.

FIG. 26 is a flow chart of a bet addition process program of the slot machine according to the third embodiment.

FIG. 27 shows each storage area of ROM according to a fourth embodiment.

FIGS. 28A and 28B show examples of probability tables according to the fourth embodiment.

FIG. 29 shows an example of an additional bet lottery table according to the fourth embodiment.

FIG. 30 is a flow chart of a main process program of the slot machine according to the fourth embodiment.

FIG. 31 is a flow chart of a bet addition process program of the slot machine according to the fourth embodiment.

FIG. 32 is a flow chart of a lottery process program of the slot machine according to the fourth embodiment.

FIG. 33 is a flow chart of a base game process program of the slot machine according to the fourth embodiment.

FIG. 34 is a flow chart of a bonus game process program of the slot machine according to the fourth embodiment.

FIGS. 35A through 35E show schematically series of symbol arrays of seventh through eleventh reel bands in replacement of first through fifth reel bands during the additional bet process.

### DESCRIPTION OF THE PREFERRED EMBODIMENT

Hereinafter, in a gaming machine according to the present invention, a detailed explanation will be made for a slot machine as one of the embodiments. In this embodiment, by way of example, payout data are stored in a table (being referred to as “payout table”) listing each number of game media to be paid out for each winning combination.

### First Embodiment

A slot machine according to a first embodiment comprises a slot machine which utilizes a so-called video reel and is capable of a bet addition process to perform a lottery to determine whether to conduct a bet addition to increment a bet number without insertion of any coins during a period until the reel having a plurality of symbols thereon, after being displayed variably, is stopped. In this embodiment, an explanation will be made in the case that the number of coins to be paid out differs depending on an added bet number being won in a lottery.

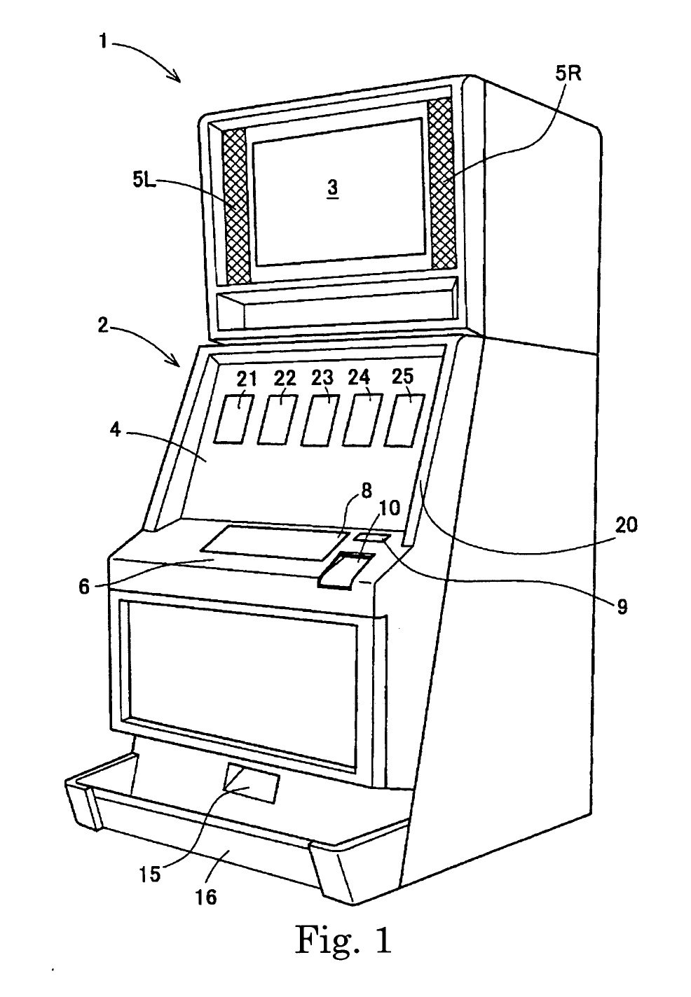

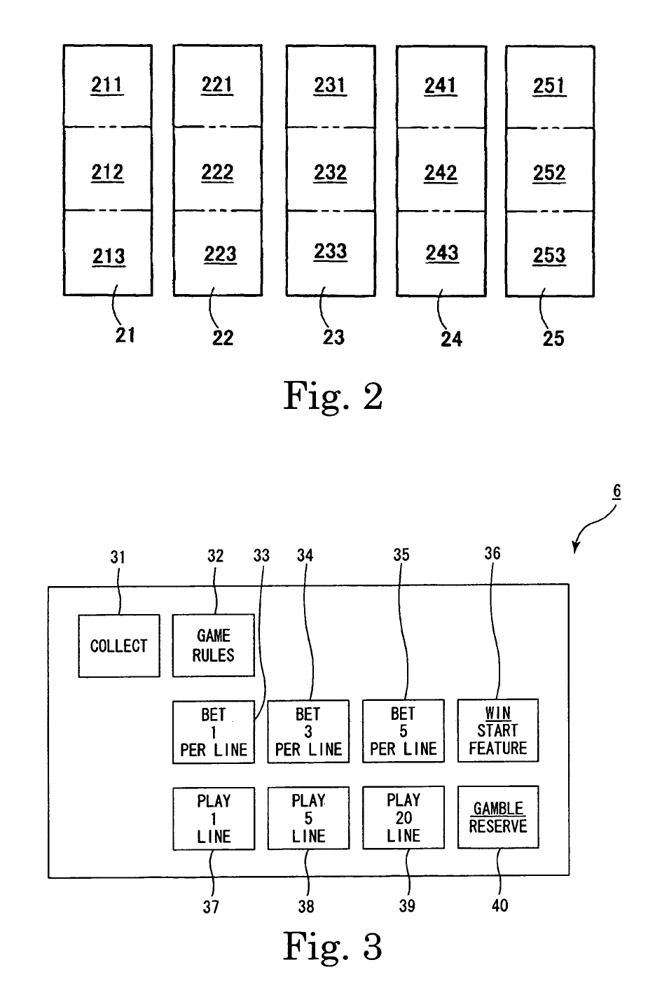

First, a general configuration of the slot machine of the first embodiment is explained in reference to FIGS. 1 through 3. FIG. 1 is a perspective view showing an outer appearance of the slot machine of the first embodiment. FIG. 2 is a front view of variable display parts of the slot machine of the first embodiment. FIG. 3 is a front view of an operation panel of the slot machine of the first embodiment.

In FIG. 1, the slot machine 1 comprises: a cabinet 2 forming an outer shape thereof; an upper liquid crystal display 3 being positioned on an upper part of the cabinet 2; a lower liquid crystal display 4 being provided on a machine front panel 20 positioned on a front and center part of the cabinet 2. Here, the upper liquid crystal display 3 and the lower liquid crystal display 4 are composed of commercially available liquid crystal display panels.

A pair of speakers 5L, SR are provided on left and right sides of the upper liquid crystal display 3, respectively such that predetermined background music (BGM), voice, effect sound and so on are outputted therefrom to a player according to a game state of the slot machine 1. Further, an operation table 6 projecting from the front face of the cabinet 2 in a ledge-like shape is provided below the lower liquid crystal display 4. The operation table 6 is provided from left to right with an operation panel having various kinds of buttons, a coin insertion part 9 through which game media such as coins are inserted, and a bill insertion part 10 through which paper money is inserted.

The upper liquid crystal display 3 displays a game method, the number of medals to be paid out according to a winning combination in a current mode, various kinds of effects relating to the game, and game information of the game. The lower liquid crystal display 4 displays variable display parts 21, 22, 23, 24 and 25 in a middle area thereof along with the credit number currently owned by the player and various kinds of effect images. And in each variable display part 21, 22, 23, 24, 25, various kinds of symbols as described later are displayed variably as they are scrolled from the top to the bottom of each variable display part, and the variable display comes to a halt after a predetermined period of elapsing time and a predetermined combination of symbols are displayed in a stationary manner.

Therefore, the slot machine 1 of the first embodiment is a so-called video slot machine where a slot game, which usually comprises two kinds of game modes such as a base game mode and a bonus game mode, is conducted with video reels realized by each variable display part 21, 22, 23, 24, 25 of the lower liquid crystal display 4 which shows the symbols variably. Here, in the slot game (in a base game mode and a bonus game mode) of the first embodiment, each variable display part 21, 22, 23, 24, 25 has three areas where respective three symbols are displayed in a stationary manner (fifteen (15) symbols in total). Specifically, as shown in FIG. 2, the variable display parts 21, 22, 23, 24, 25 have first stationary display areas 211, 221, 231, 241, 251; second stationary display areas 212, 222, 232, 242, 252; and third stationary display areas 213, 223, 233, 243, 253. Predetermined symbols are displayed in a stationary manner in the respective stationary display areas 211 to 213, 221 to 223, 231 to 233, 241 to 243, and 251 to 253 according to a lottery result of an internal lottery to be described later

Further, in the slot game, which usually comprises a base game mode and a bonus game mode, these stationary display areas 211 to 213, 221 to 223, 231 to 233, 241 to 243, and 251 to 253 cause twenty (20) pay lines being composed of five (5) areas of the five variable display parts, respectively. In each pay line (if activated), a payout is provided to the player when specific symbols are aligned along the activated pay line in a specific manner as the symbols are displayed in a stationary manner. Now, each pay line will be explained below.

A first pay line L1 is formed by the second stationary display areas 212, 222, 232, 242, 252. A second pay line L2 is formed by the first stationary display areas 211, 221, 231, 241, 251. A third pay line L3 is formed by the third stationary display areas 213, 223, 233, 243, 253. A fourth pay line L4 is formed by the first stationary display areas 211, 221, 231, 241 and the third stationary display area 253. A fifth pay line L5 is formed by the first stationary display area 251, the third stationary display areas 213, 223, 233, 243. A sixth pay line L6 is formed by the first stationary display areas 211, 221, 231, 241 and the second stationary area 252. A seventh pay line L7 is formed by the second stationary area 252 and the third stationary areas 213, 223, 233, 243. An eighth pay line L8 is formed by the first stationary display areas 211, 221, 231, 251 and the second stationary area 242. A ninth pay line L9 is formed by the second stationary display area 242 and the third stationary display areas 213, 223, 233, 253. A tenth pay line L10 is formed by the first stationary display areas 211, 221, 231 and the third stationary display areas 243, 253. An eleventh pay line L12 is formed by the first stationary display areas 241, 251, 231 and the second stationary display area 222 and the third stationary display area 213. A twelfth pay line L12 is formed by the first stationary display areas 211, 221, 231, 251 and the third stationary display area 243. A thirteenth pay line L13 is formed by the first stationary display area 241 and the third stationary display areas 213, 223, 233, 253. A fourteenth pay line L14 is formed by the first stationary display areas 241, 251 and the second stationary display areas 212, 222, 232. A fifteenth pay line L15 is formed by the second stationary display areas 212, 222, 232 and the third stationary display areas 243, 253. A sixteenth pay line L16 is formed by the first stationary display area 241 and the second stationary display areas 212, 222, 232, 252. A seventeenth pay line L17 is formed by the second stationary display areas 212, 222, 232, 252 and the third stationary display area 243. An eighteenth pay line L18 is formed by the first stationary display area 251 and the second stationary display area 212, 222, 232, 242. A nineteenth pay line L19 is formed by the second stationary display areas 212, 222, 232, 242 and the third stationary display area 253. A twentieth pay line L20 is formed by the first stationary display areas 241, 251 and the second stationary display areas 212, 222 and the third stationary display area 233.

Now, the pay line(s) of the twenty (20) pay lines which are activated based on an operation of each bet button (BET1 PER LINE button 33, BET3 PER LINE button 34, BET5 PER LINE button 35) is(are) referred to as “activated pay line(s)” hereafter.

The lower liquid crystal display 4 may work as variable display means. In the present invention, the variable display means is not limited to the liquid crystal display, which shows variable display and stationary display of the symbols as images displayed on the screen electronically, but may show the variable display and stationary display of the symbols mechanically with rotating reels.

Various kinds of operation buttons are disposed on an operation panel 8 provided on the operation table 6. Each operation button is concretely explained in reference to FIG. 3. From the left side, COLLECT button 31 and GAME-RULES button 32 are provided in the top row on the operation panel 8. From the left side, BET-1-PER-LINE button 33, BET-3-PER-LINE button 34, BET-5-PER-LINE button 35 and WIN-START-FEATURE button 36 are provided in the middle row on the operation panel 8. From the left side, PLAY-1-LINE button 37, PLAY-5-LINE button 38, PLAY-20-LINE button 39 and GAMBLE-RESERVE button 40 are provided in the bottom row on the operation panel 8.

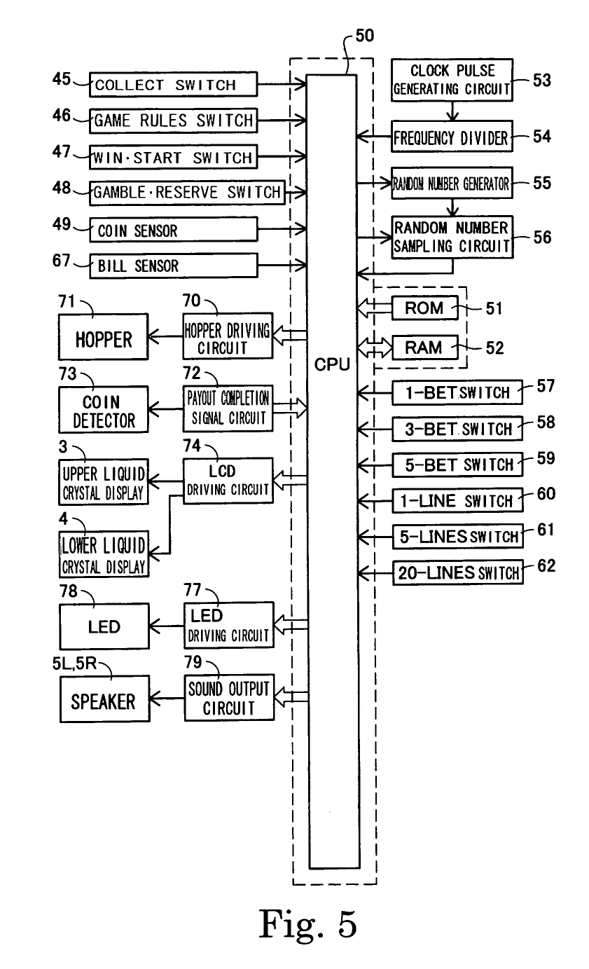

Here, the COLLECT button 31 is a button which is usually depressed at the end of the game such that a certain number of coins equivalent to the credit number having been obtained in the game are paid out into the coin receiving part 16 through a coin payout opening 15 to be described later via a hopper (not shown) installed inside the slot machine 1 when the COLLECT button 31 is depressed. There is a COLLECT switch 45 attached to the COLLECT button 31 such that a switch signal is transmitted to the CPU 50 based on the depression of the COLLECT button 31 (refer to FIG. 5). The GAME-RULES button 32 is a button which the player depresses if he or she is not sure about how to operate the gaming machine in the game. And when the GAME-RULES button 32 is depressed, help information for each case is displayed on the upper liquid crystal display 3 and the lower liquid crystal display 4. To the GAME-RULES button 32, GAME-RULES switch 46 is attached such that a switch signal is transmitted from the GAME-RULES switch 46 to the CPU 50 (refer to FIG. 5) according to depression of the GAME-RULES button 32.

The BET-1-PER-LINE button 33 is a button to bet one by one for each activated pay line from the deposited credit currently owned by the player as the BET-1-PER-LINE button 33 is depressed once. To the BET-1-PER-LINE button 33, 1-BET switch 57 is attached such that a switch signal is transmitted from the 1-BET switch 57 to the CPU 50 (refer to FIG. 5).

The BET-3-PER-LINE button 34 is a button to start the game with three bets for each activated pay line according to depression thereof. To the BET-3-PER-LINE button 34, 3-BET switch 58 is attached such that a switch signal is transmitted from the 3-BET switch 58 to the CPU 50.

Further, the BET-5-PER-LINE button 35 is a button to start the game with five bets for each activated pay line according to depression thereof. To the BET-5-PER-LINE button 35, 5-BET switch 59 is attached such that a switch signal is transmitted from the 5-BET switch 59 to the CPU 50.

Therefore, the bet number for each pay line of the activated pay lines is determined by depression of BET-1-PER-LINE button 33, BET-3-PER-LINE button 34 and BET-5-PER-LINE button 35.

Also, the WIN-START-FEATURE button 36 is a button to start a bonus game to be described later and add the payout amount obtained in the bonus game to the credit. To the WIN-START-FEATURE button 36, WIN-START switch 47 is attached such that a switch signal is transmitted from the WIN-START switch 47 to the CPU 50 (refer to FIG. 5).

The PLAY-1-LINE button 37 is a button to start the game as the number of activated pay line is set at “one” according to depression thereof. To the PLAY-1-LINE button 37, 1-LINE switch 60 is attached such that a switch signal is transmitted from the 1-LINE switch 60 to the CPU 50 (refer to FIG. 5).

The PLAY-5-LINE button 38 is a button to start the game as the number of activated pay lines is set at “five” according to depression thereof. To the PLAY-5-LINE button 38, 5-LINES switch 61 is attached such that a switch signal is transmitted from the 5-LINES switch 61 to the CPU 50 (refer to FIG. 5).

The PLAY-20-LINE button 39 is a button to start the game as the number of activated pay lines is set at “20” according to depression thereof. To the PLAY-20-LINE button 39, 20-LINES switch 62 is attached such that a switch signal is transmitted from the 20-LINES switch 62 to the CPU 50 (refer to FIG. 5).

Therefore, the number of the activated pay lines is determined by depression of PLAY-1-LINE button 37, PLAY-5-LINE button 38 and PLAY-20-LINE button 39.

Here, the first pay line described before is activated when the PLAY-1-LINE button 37 is depressed. Also, the first pay line L1 through the fifth pay line L5 are activated when the PLAY-5-LINE button 38 is depressed. Also, the first pay line L1 through the twentieth pay line L20 are activated when the PLAY-20-LINE button 39 is depressed.

Further, the PLAY-1-LINE button 37, the PLAY-5-LINE button 38 and the PLAY-20-LINE button 39 may work as the start button to start, upon depression thereof, variable displays of the symbols in respective variable display parts 21 to 25 on the lower liquid crystal display 4 so as to start the game with the current bet number and the number of the currently-activated pay lines.

The GAMBLE-RESERVE button 40 is a button to be depressed when the player leaves the seat and when the player shift the game to a double down game after completion of the bonus game. Here, the double down game is a game to be played by utilizing the credit amount obtained in the bonus game. The detailed explanation is omitted. To the GAMBLE-RESERVE button 40, GAMBLE-RESERVE switch 48 is attached such that a switch signal is transmitted from the GAMBLE-RESERVE switch 48 to the CPU 50 (refer to FIG. 5).

A coin sensor 49 is disposed on the coin insertion part 9 such that a coin detection signal is transmitted from the coin sensor 49 to the CPU 50 (refer to FIG. 5) and the credit amount equivalent to the inserted coins is added. A bill sensor 67 is disposed on the bill insertion part 10 such that the credit amount equivalent to the inserted coins is added.

A coin payout opening 15 and a coin receiving part 16 are formed at a lower part of the cabinet 2. A coin detector 73, to be described later, being composed of a hopper 71 capable of discharging coins one by one is disposed inside the coin payout opening 15 (refer to FIG. 5) and the coin detector detects the number of coins paid out from the coin payout opening 15. Further, a piece of paper such as a receipt on which the number of coins (value) is written may be discharged instead of coins. In such a case, the player can obtain goods (or merchandise) in exchange of the piece of paper if the player brings the piece of paper to the counter or the like of the arcade. Here, one game may include a series of actions of the bet operation based on the currently-owned credit, the variable display and stationary display of the symbols and various kinds of processes (e.g., bonus game process and payout process) in accordance with the combination of symbols displayed in a stationary manner.

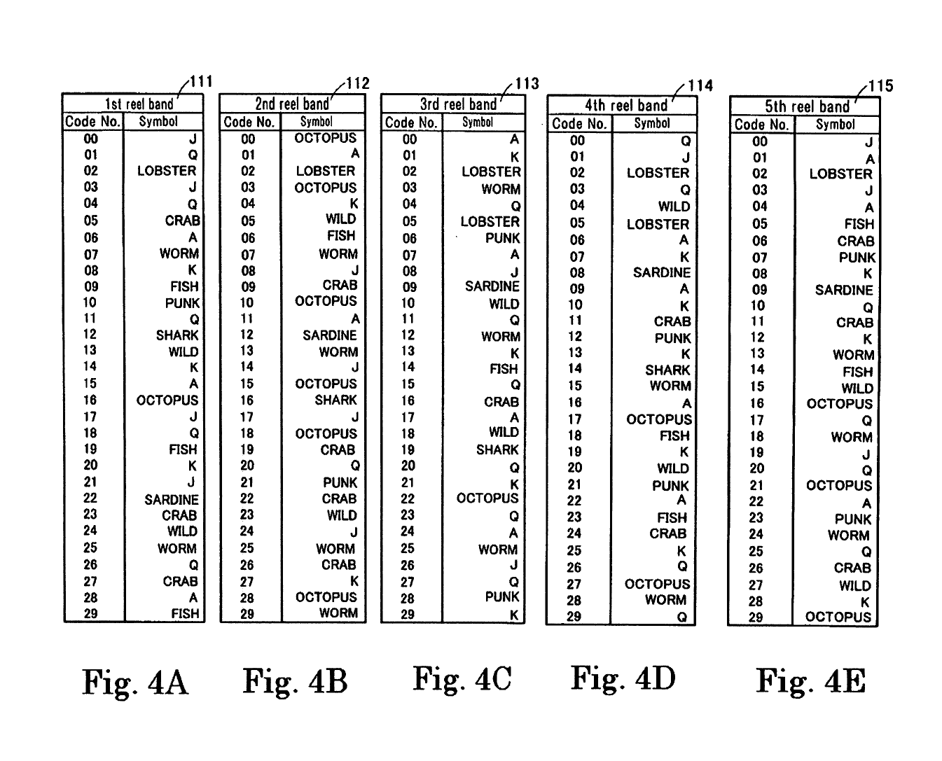

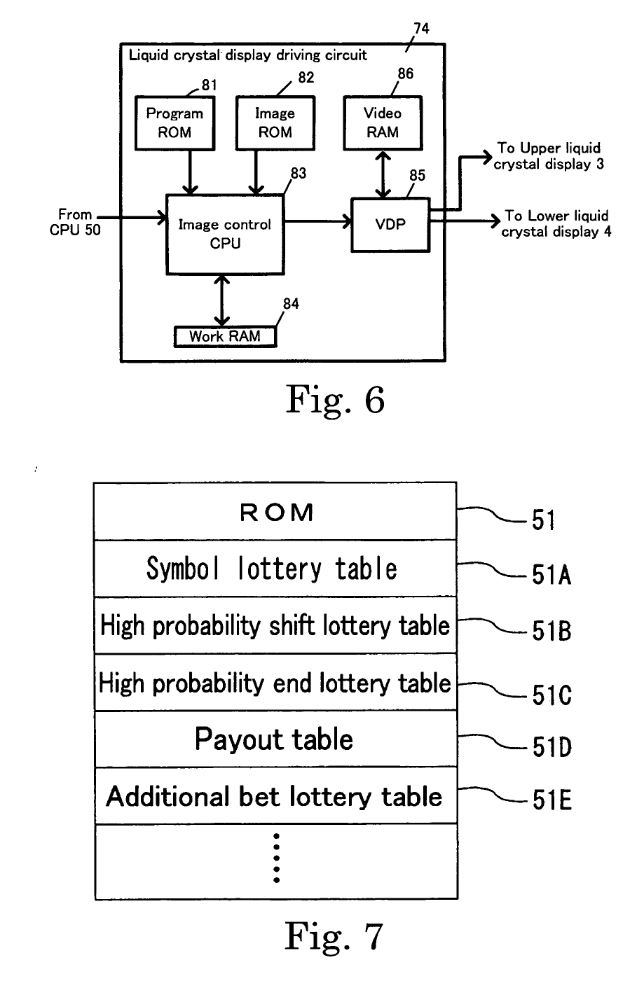

Further, in reference to FIGS. 4A through 4E, examples of the variably-displayed symbols as being scrolled in each variable display part 21 through 25 of the lower liquid crystal display 4 are explained. In FIG. 4A, an array of symbols shown in a first reel band 111 is an array of symbols which are variably displayed in the variable display part 21. In FIG. 4B, an array of symbols shown in a second reel band 112 is an array of symbols which are variably displayed in the variable display part 22. In FIG. 4C, an array of symbols shown in a third reel band 113 is an array of symbols which are variably displayed in the variable display part 23. In FIG. 4D, an array of symbols shown in a fourth reel band 114 is an array of symbols which are variably displayed in the variable display part 24. In FIG. 4E, an array of symbols shown in a fifth reel band 115 is an array of symbols which are variably displayed in the variable display part 25. Here, dot data to form images indicated in the arrays of symbols of the first reel band 111 through the fifth reel band 115 are stored in an image ROM 82 (refer to FIG. 6).

Here, the arrays of symbols shown in the first reel band 111 through the fifth reel band 115 are different one another and the arrays of symbols are composed of thirteen kinds of symbols: “SHARK”, “FISH”, “PUNK”, “OCTOPUS”, “CRAB”, “WORM” and “SARDINE”, but arranged in different manners, respectively.

Here, “LOBSTER” indicates an image of a lobster. Also, “SHARK”, “FISH”, “PUNK”, “OCTOPUS”, “CRAB”, “WORM” and “SARDINE” indicate images of a shark, fish, a person with a guitar, an octopus, a worm and a sardine, respectively. Further, “A”, “K”, “Q”, “J” and “WILD” indicate alphabet images of alphabetic characters thereof, respectively.

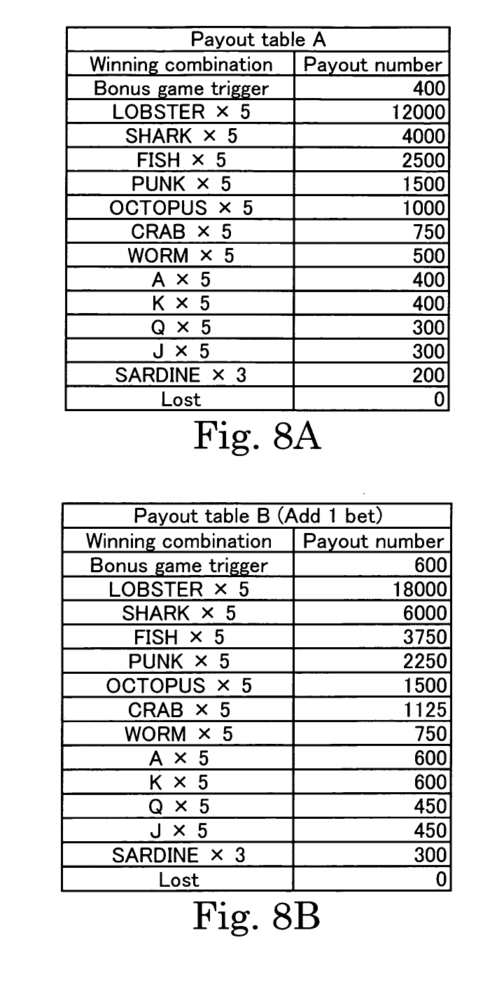

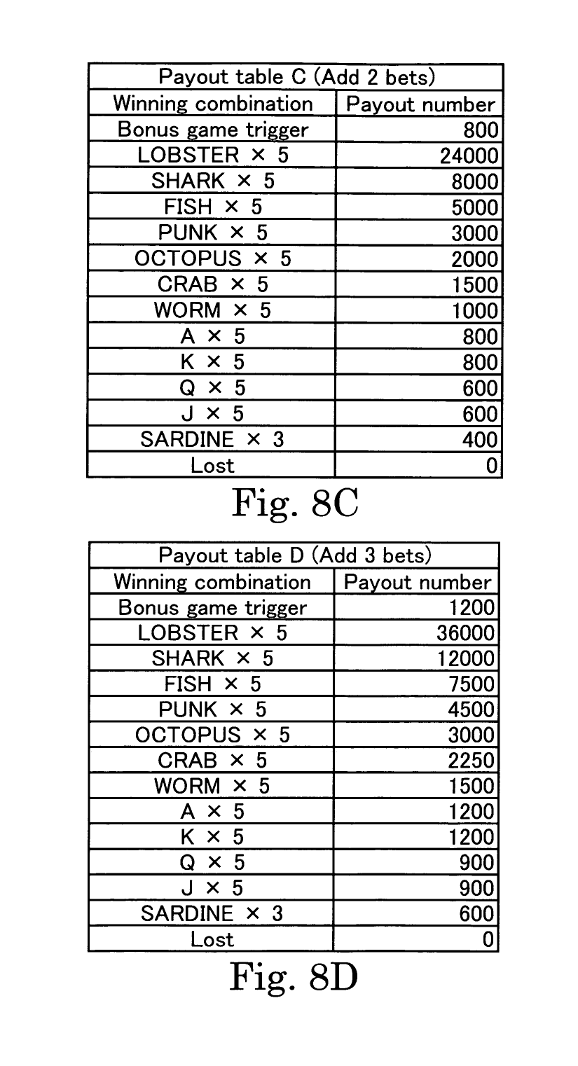

And if a predetermined number of “LOBSTER”, “SHARK”, “FISH”, “PUNK”, “OCTOPUS”, “CRAB”, “WORM”, “A”, “K”, “Q” and “J” are displayed consecutively in a stationary manner along any of the first to the twentieth pay lines L1 to L20 from the left side, a predetermined credit number is added to the credit the player owns (refer to FIGS. 8A to 8D). Here, “SARDINE” is a so-called scattered symbol such that a predetermined credit number is added to the credit the player owns if more than a predetermined number of “SARDINE” symbols (for example, “three” in the first embodiment) are displayed in the variable display parts 21 through 25 irrespective of the activated pay lines (refer to FIGS. 8A to 8D). Further, as described later, “SARDINE” is also a bonus game shift symbol to let the game shift into the bonus game mode such that the game may shift into the bonus game mode if a predetermined number of “SARDINE” symbols (for example, “five” in the first embodiment) are displayed in a stationary manner in the variable display parts 21 to 25. Also, “WILD” is a so-called wild symbol, which can be regarded as any kind of symbol other than “SARDINE” (scatter symbol).

And the arrays of symbols indicated by the first reel 111 through the fifth reel are displayed as being scrolled from the top to the bottom in each variable display part 21 to 25 when one of the PLAY-1-LINE button 37, the PLAY-5-LINE button 38 and the PLAY-20-LINE button 39 is depressed to start the game. After a predetermined period of time, three symbols are stopped and displayed in each variable display part. Further, various kinds of winning combinations of symbols described above are set beforehand (refer to FIGS. 8A to 8D) and the payout for each winning combination is added to the credit if the combination of symbols corresponding to any of the winning combinations come to a halt and are displayed along any of the activated pay lines. Further, if the predetermined number of “SARDINE” symbols are stopped and displayed in the variable display parts 21 to 25 irrespective of the activated pay lines, the game shifts to the bonus game.

On the other hand, when one game (Here, “one game” is from starting the variable display of the symbols in the variable display parts 21 to 25 to stopping and displaying the symbols in a stationary manner.) is completed, a lottery is conducted to determine whether the game shifts into a high probability mode, in which the probability of stopping any one of the winning combinations along any of the activated pay lines for the next game. As a result, if it is determined to shift into the high probability mode, the high probability mode remains from the next game until any of the termination conditions is satisfied. Here, the high probability mode will be explained in detail later.

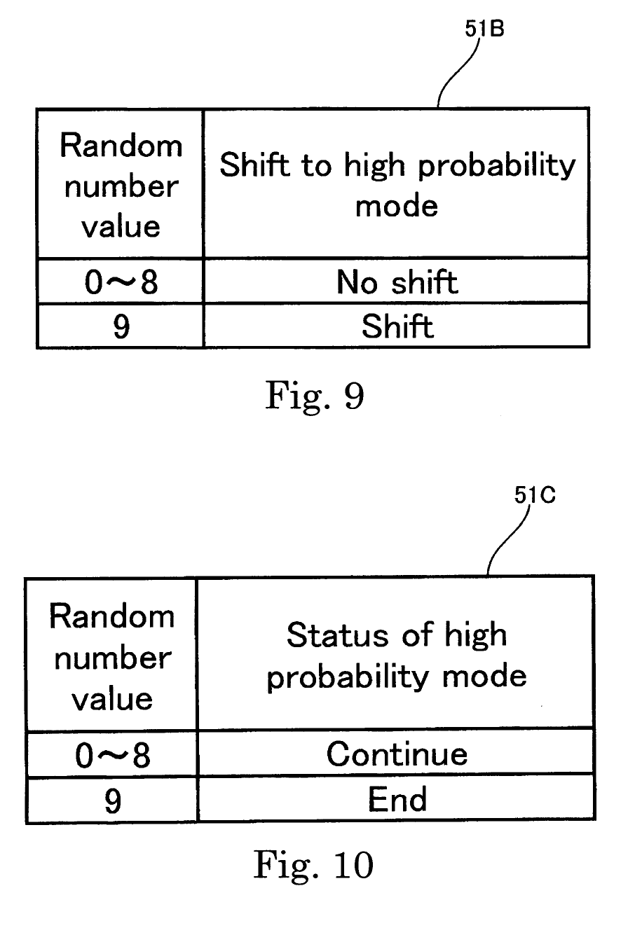

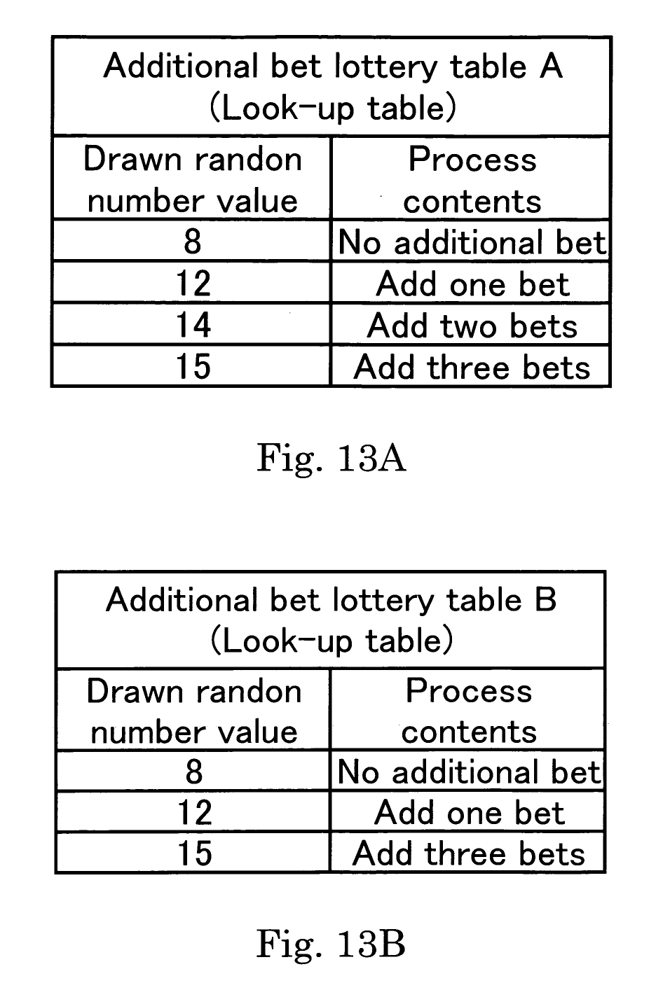

Next, the configuration of the control system of the slot machine 1 is explained in reference to FIG. 5. FIG. 5 is a block diagram showing schematically the control system of the slot machine 1. In FIG. 5, the control system of the slot machine 1 is basically composed of the CPU 50 as a kernel thereof and the CPU 50 is connected to ROM 51 and RAM 52. The ROM 51 stores a main process program to be described later, a base game process program, a bonus game process program, a high probability mode process program, a symbol lottery table to select symbols displayed in a stationary manner, a plurality of payout tables listing the number of payout medals for each winning combination (refer to FIGS. 8A through 8D), a high probability shift lottery table to determine whether to start the high probability mode or not (refer to FIG. 9), a high probability end lottery table to determine whether to terminate the high probability mode or not (refer to FIG. 10), an additional bet lottery table to determine whether to conduct an additional bet or not (FIG. 13), voice data of each character to be outputted from the speakers during the effect display, and other various kinds of programs, data tables, etc. necessary for controlling the slot machine 1.

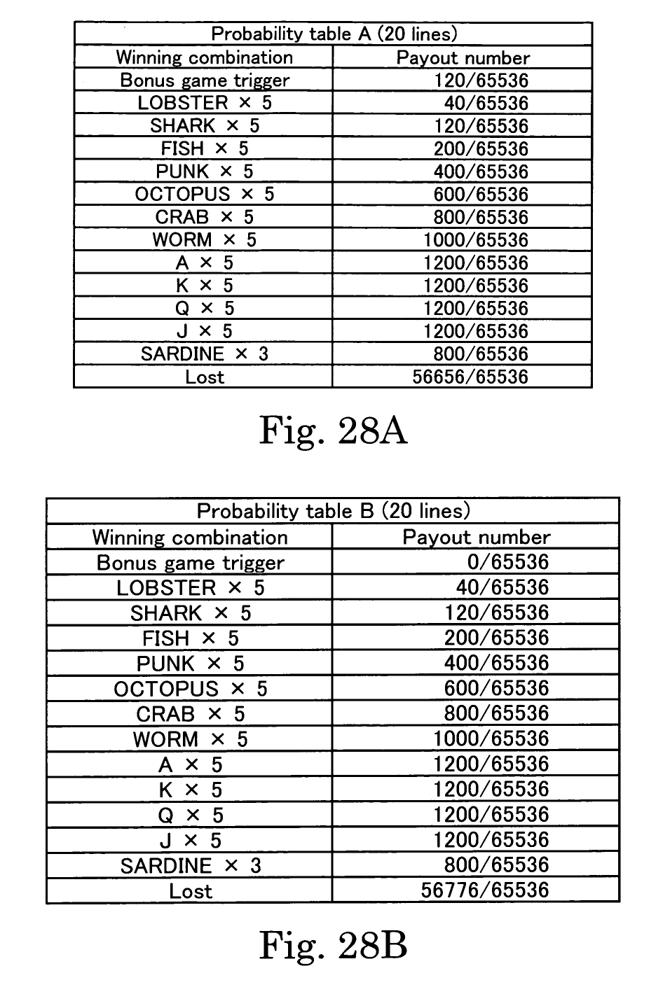

In another embodiment to be described later, the ROM 51 also stores two kinds of probability tables defining the winning probability for each winning combination (refer to FIGS. 28A and 28B).

The plurality of kinds of payout tables are prepared for the additional bet number of “one”, the additional bet number of “two” and the additional bet number of “three”, respectively. And the number of payout medals is determined by referring to the payout table corresponding to the additional bet number at the point so that the number of actually-paid medals is given by multiplying a resultant payout number thereof by the bet number (excluding the additional bet number). The ROM 51 works as payout data storage means for storing a plurality of kinds of payout tables to determine the number of payout medals for each winning combination. Also, the RAM 52 is a memory for storing temporarily various kinds of data calculated by the CPU 50.

Also, the CPU 50 is connected to a clock pulse generating circuit 53 and a frequency divider 54, and further it is connected to a random number generator 55 and a random number sampling circuit 56. The random number sampled by the random number sampling circuit 56 is utilized for various kinds of lotteries to select the winning combination or the like. Further, the CPU 50 is connected to the COLLECT switch 45 attached to the COLLECT button 31, the GAME-RULES switch 46 attached to the GAME-RULES button 32, 1-BET switch 57 attached to the BET-1-PER-LINE button 33, 3-BET switch 58 attached to the BET-3-PER-LINE button 34, 5-BET switch 59 attached to the BET-5-PER-LINE button 35, WIN-START switch 47 attached to the WIN-START-FEATURE button 36, 1-LINE switch 60 attached to the PLAY-1-LINE button 37, 5-LINES switch 61 attached to the PLAY-5-LINE button 38, 20-LINES switch 62 attached to the PLAY-20-LINE button 39, and GAMBLE-RESERVE switch 48 attached to the GAMBLE-RESERVE button 40. The CPU 50 conducts a control to carry out each kind of operation corresponding to each button based on the switch signal transmitted from each switch upon depression of each button.

Further, the CPU 50 is connected to the coin sensor 49 arranged in the coin insertion part 9 and the bill sensor 67 arranged in the bill insertion part 10. The coin sensor 49 detects coins inserted through the coin insertion part 9 and the CPU 50 calculates the number of the inserted coins based on the coin detection signal transmitted from the coin sensor 49. The bill sensor 67 detects the kind and the amount of the bill inserted through the bill insertion part 10 and the CPU 50 calculates the credit number equivalent to the amount of the bill based on the bill detection signal transmitted from the bill sensor 67.

The CPU 50 is connected to a hopper 71 through a hopper driving circuit 70. When a driving signal is transmitted from the CPU 50 to hopper driving circuit 70, the hopper 71 pays out the predetermined number of coins through the coin payout opening 15. Further, the CPU 50 is connected to the coin detector 73 via the payout completion signal circuit 72. The coin detector 73 is disposed inside the coin payout opening 15 and if the coin detector 73 detects the predetermined number of coins are paid out, a coin payout detection signal is transmitted from the coin detector 73 to the payout completion signal circuit 72 such that the payout completion signal circuit 72 outputs the payout completion signal to the CPU 50. Further, the CPU 50 is connected to the upper liquid crystal display 3 and the lower liquid crystal display 4 via the liquid crystal driving circuit 74 such that the CPU 50 controls the upper liquid crystal display 3 and the lower liquid crystal display 4.

In this point, the liquid crystal driving circuit 74 is configured with a program ROM 81, an image ROM 82, an image control CPU 83, a work RAM 84, VDP (video-display-processor) 85, a video RAM 86 and so on. And the program ROM 81 stores an image control program and various kinds of selection tables relating to the display on the upper liquid crystal display 3 and the lower liquid crystal display 4. Also, the image ROM 82 stores dot data for forming images such as payout display images displayed on the upper liquid crystal display 3 and the first reel band 111 through the fifth reel band 115 as shown in FIGS. 4A through 4E to be displayed on the lower liquid crystal display 4. The image control CPU 83 determines images to be displayed on the upper liquid crystal display 3 and the lower liquid crystal display 4 among the dot data having been stored beforehand in the program ROM 81 based on a parameter set by the CPU 50. Also, the work RAM 84 is configured as a temporal storage means when the image control program is executed by the image control CPU 83. Also, the VDP 85 forms an image corresponding to the display content having been determined by the image control CPU 83 and outputs such an image to the upper liquid crystal display 3 and the lower liquid crystal display 4. Thus, the arrays of symbols indicated by the reel bands 111 through 115 are scrolled and displayed on the lower liquid crystal display 4 (or in the variable display parts 21 through 25), for example. Here, the video RAM 86 is configured as temporal storage means to form an image with the VDP 85.

Also, the CPU 50 is connected to a LED 78 via a LED driving circuit 77. The LED 78 is controlled by the LED driving circuit 77 to blink based on a driving signal transmitted from the CPU 50 as various kinds of effects are performed on the front face of the slot machine on which many LED elements are provided. In particular, in the slot machine 1 of the first embodiment, the LED 78 is lit to enhance the effects during the high probability mode to be described later.

Also, the CPU 50 is connected to a sound output circuit 79 and speakers 5L, 5R such that the speakers 5L, 5R generate voices and effect sounds when various effects are performed in accordance with an output signal from the sound output circuit 79.

Also, as shown in FIG. 7, the ROM 51 stores a symbol lottery table 51A to determine the symbols to be stopped and displayed in the stationary display areas 211 through 213, 221 through 223, 231 through 233, 241 through 243, and 251 through 253 of the respective variable display parts 21 through 25 based on the random number (refer to FIG. 2), a high probability shift lottery table 51B to determine whether to start the next game in the high probability mode or not upon completion of every game having been conducted not in the high probability mode, a high probability end lottery table 51C to determine whether to terminate the high probability mode for the next game or not upon completion of every game having been conducted in the high probability mode, a payout table 51D storing the payout amount in associated with the winning combination of symbols having been displayed the respective stationary display areas, and an additional bet lottery table 51E for conducting a lottery to determine whether to conduct an additional bet or not. The ROM 51 works as payout data storage means for storing a plurality of payout tables as the payout data.

Here, in another embodiment, the ROM 51 may work as payout data storage means for storing a plurality of additional bet lottery tables to determine whether to conduct the additional bet or not. The detail thereof will be described later.

First, in the case that the game in the base game mode and the game in the bonus game mode are conducted by utilizing the variable display parts 21 through 25 in the slot machine 1, the symbol lottery table 51A which is stored in the ROM 51 and utilized to determine the symbols to be displayed in a stationary manner in the respective stationary display areas 211 through 213, 221 through 223, 231 through 233, 241 through 243, and 251 through 253 (refer to FIG. 2) is explained.

The symbol lottery table 51A is a lottery table to conduct a lottery to select the symbols to be stopped along the first activated pay line being composed of the second stationary display areas 212, 222, 232, 242, 252 based on a value of a random number sampled by the random number sampling circuit 56. And once the symbols to be stopped at the second stationary display areas 212, 222, 232, 242, 252 are determined, the symbols to be displayed in a stationary manner at the first and third stationary display areas (above and below the respective second stationary display areas) 211, 213, 221, 223, 231, 233, 241, 243, 251, 253 are fixed according to the arrays of symbols in the respective reel bands (refer to FIG. 4). More specifically, symbols corresponding to code numbers which are one point smaller than respective code numbers having been determined based on the random numbers are displayed in a stationary manner at the first stationary display areas 211, 221, 231, 241, 251, and symbols corresponding to code numbers which are one point larger than the respective code numbers are displayed in a stationary manner at the third stationary display areas 213, 223, 233, 243, 253.

Also, according to the slot machine 1 of the first embodiment, the symbols displayed in a stationary manner along the activated pay line L1 are determined by each variable display part 21 through 25. The symbol lottery table 51A set the code numbers “00” through “29” to respective arrays of symbols indicated by the first reel band 111 through the fifth reel band 115 as shown in FIG. 4. And the CPU 50 conducts a sampling of five random numbers corresponding to respective variable display parts 21 through 25 via the random number sampling circuit 56 and determines the symbols to be displayed in a stationary manner at the second stationary display areas 212, 222, 232, 242, 252 of respective variable display parts 21 through 25 (By way of example, suppose the sampled random number is “9”. The symbol of “FISH” to which the code number of “09” is assigned is displayed in a stationary manner at the second stationary display area.).

Also, the high probability shift lottery table 51B is a lottery table for conducting a lottery to determine whether to let the game shift into the high probability mode or not based on a random number sampled by the sampling circuit 56 upon completion of one game having been not in the high probability mode. Here, the probability shift lottery table 51B will be described in detail later.

Also, the high probability end lottery table 51C is a lottery table for conducting a lottery to determine whether to terminate the high probability mode or not based on the random number sampled by the sampling circuit 56 upon completion of one game that has been in the high probability mode. Here, the probability end lottery table 51C will be explained in detail later.

Next, the winning combination and a payout thereof are explained in reference to FIGS. 8A to 8D in the case that the game in the base game mode and the game in the bonus game mode are conducted by utilizing the five variable display parts 21 through 25 in the slot machine.

FIG. 8A shows a payout table (payout table A) without any additional bet, FIG. 8B shows a payout table (payout table B) with one additional bet, FIG. 8C shows a payout table (payout table C) with two additional bets, and FIG. 8D shows a payout table (payout table D) with three additional bets. Here, the payout tables shown in FIGS. 8A to 8D show payout values in the case that the bet number is “5” before the additional bet. Therefore, in the case that the bet number is “5” before the additional bet, the payout values shown in FIGS. 8A to 8D are added to the credit. However, in the case that the bet number is other than “5” before the additional bet, that is, the bet number is “N” (N is a natural number less than 5.), the payout values shown in FIGS. 8A to 8D are multiplied by N/5 and the results are added to the credit.

As shown in FIG. 8A, the payout number of “400” is associated with the bonus game trigger in the payout table A. The payout number of “12000” is also associated with “LOBSTER×5”. The payout number of “4000” is also associated with “SHARK×5”. The payout number of “2500” is also associated with “FISH×5”. The payout number of “1500” is also associated with “PUNK×5”. The payout number of “1000” is also associated with “OCTOPUS×5”. The payout number of “750” is also associated with “CRAB×5”. The payout number of “500” is also associated with “WORM×5”. The payout number of “400” is also associated with “A×5”. The payout number of “400” is also associated with “K×5”. The payout number of “300” is also associated with “Q×5”. The payout number of “300” is also associated with “J×5”. The payout number of “200” is also associated with “SARDINE×3”.

Further, as shown in FIG. 8B, the payout number for each winning combination is listed in the payout table B. The payout number for each winning combination except “Lost” is 1.5 times as many as the corresponding payout number listed in the payout table A (refer to FIG. 8A).

Further, as shown in FIG. 8C, the payout number for each winning combination is listed in the payout table C. The payout number for each winning combination except “Lost” is twice as many as the corresponding payout number listed in the payout table A (refer to FIG. 8A).

Further, as shown in FIG. 8D, the payout number for each winning combination is listed in the payout table D. The payout number for each winning combination except “Lost” is three times as many as the corresponding payout number listed in the payout table A (refer to FIG. 8A). The payout table D may be selected only when the bet number is the MAX bets (for example, “5” in the first embodiment) to be explained in detail later. The payout table D corresponds to the maximum payout data in the present invention.

Next, the bonus game is explained. If five bonus trigger symbols appear (are displayed in a stationary manner) at the same time in the variable display parts 21 through 25 irrespective of the activated pay lines in this slot machine 1, the game may shift to the bonus game. Here, the bonus game is the game in the bonus game mode to be started if a specific condition is satisfied during the game in the base game mode and generally tends to be beneficial to the player. In this instance, if the game shifts to the bonus game, fifteen (15) to twenty five (25) games may be played consecutively and automatically without betting credits or the like (so-called free game) according to the lottery result at the point of shifting to the bonus game.

Here, the bet number and the number of the activated pay lines at the point of shifting to the bonus game are used in the bonus game. Also, the winning combinations and payouts thereof are the same as those of the game in the base game mode described above. However, “SHARK” symbol (shark) is handled as “LOBSTER” symbol (lobster) and if five “SARDINE” symbols in total appear (are displayed in a stationary manner), it is possible to let the game shift into the bonus game mode again. Here, as shown in FIGS. 8A to 8D, the “LOBSTER” symbol (lobster) is associated with a higher number of payouts than that of the “SHARK” symbol (shark) in the case of winning such that it is likely for the player to obtain a large number of credits or the like without consuming the owned credits.

Also, in the slot machine 1 of the first embodiment, the game in the base game mode and the game in the bonus game mode will be the game in the high probability mode and the game in the high probability bonus game mode, respectively if a predetermined condition is satisfied during the current game in the base game mode and the current game in the bonus game mode. Here, the high probability mode is a special game mode that is determined to be employed in the game according to a lottery result based on the random number sampled by the sampling circuit 56 upon completion of one game. Here, the lottery is conducted by utilizing the high probability shift lottery table 51B being stored in the ROM 51. FIG. 9 shows the high probability shift table that is used in the lottery to determine whether the game in the base game mode is shifted to the game in the high probability mode or not.

As shown in FIG. 9, the high probability shift lottery table 51B is a lottery table to conduct a lottery based on random numbers from “0” to “9” sampled by the sampling circuit 56 upon completion of one game in the base game mode. And the CPU 50 determines whether to shift to the high probability mode or remain in the base game mode based on the obtained random number value. More specifically, the game will not shift to the game in the high probability mode, but will remain in the base game mode if the random number is any of “0” to “8”. On the other hand, if the random number is “9”, the game will shift to the game in the high probability mode after completion of the current game. Therefore, upon determination of shifting to the game in the high probability mode, the next and subsequent games have higher probability to win the winning combination than in the base game mode until a predetermination of high probability end condition is satisfied. Here, one game is from starting the variable display of symbols in the variable display parts 21 through 25 to stopping and displaying the symbols.

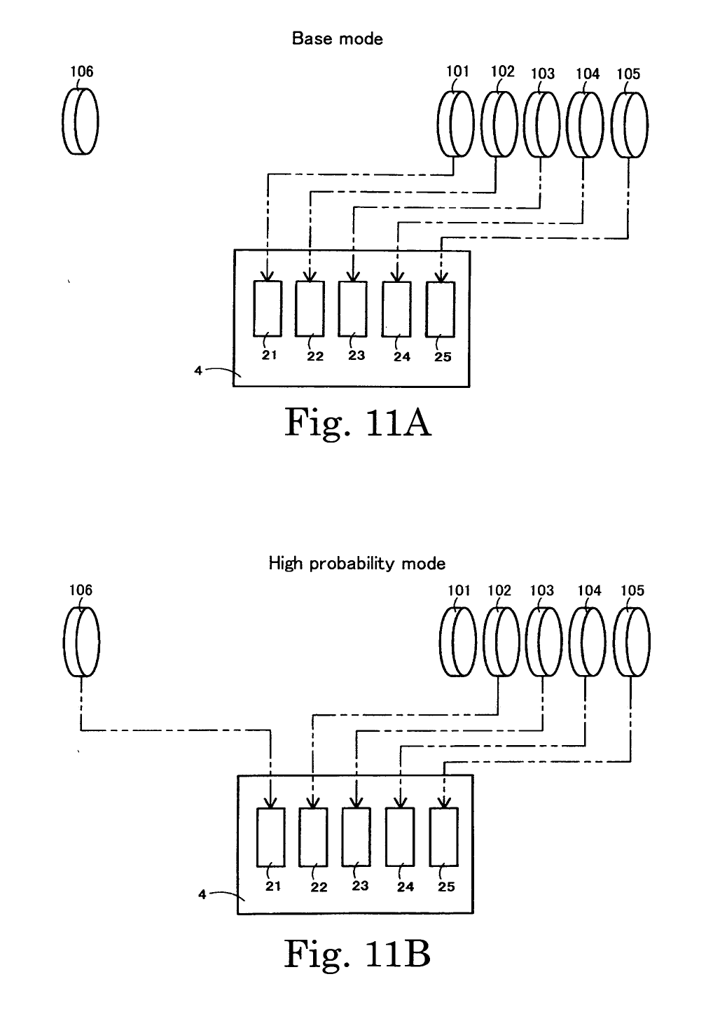

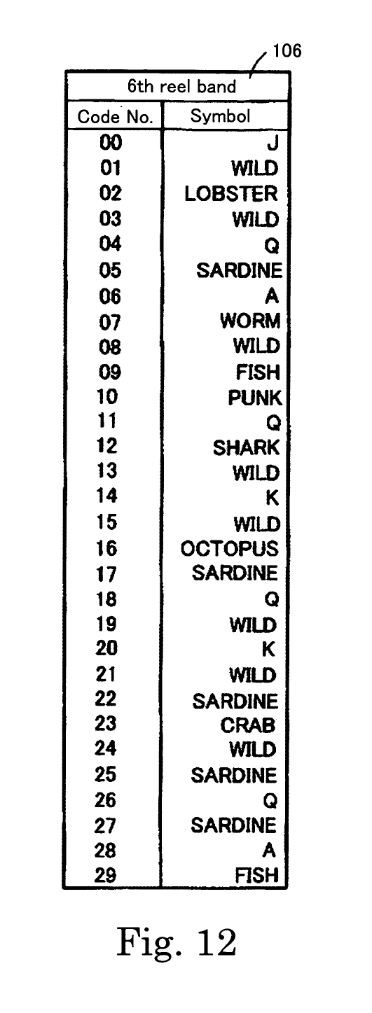

Here, in the slot machine 1 of the first embodiment, the first reel band 101 among the first reel band 101 through the fifth reel band 105 is replaced with a new sixth reel band 106 such that the game may shift into the high probability game mode. FIG. 11A is a schematic diagram showing reel bands to be variably and quiescently displayed in the variable display parts 21 through 25 in the base game mode. FIG. 11B is a schematic diagram showing reel bands to be utilized in the high probability mode. FIG. 12 is a schematic diagram showing an array of symbols variably displayed in the variable display part with the sixth reel band.

As shown in FIG. 11A, five reel bands from the first reel band 101 to the fifth reel band 105 are utilized in the game in the base game mode. As shown in FIG. 11B, the first reel band 101 is replaced with the sixth reel band 106, which is shown in the variable display part 21, in the game in the high probability mode.

The sixth reel band 106 includes more “WILD” symbols (alphabetic characters) and more “SARDINE” symbols (sardine) than the first reel band 101 as shown in FIG. 12. More specifically, the first reel band 101 has two “WILD” symbols as opposed to eight “WILD” symbols in the sixth reel band 106. Also, the first reel band 101 has one “SARDINE” symbol as opposed to four “SARDINE” symbols in the sixth reel band 106. Here, as described before, “WILD” symbol is a wild symbol which can be any symbols (“LOBSTER”, “SHARK”, “FISH, “PUNK”, “OCTOPUS”, “CRAB”, “WORM”, “A”, “K”, “Q”, and “J”) except for “SARDINE” and the probability to obtain the winning combination becomes higher in the high probability mode because of the increased number of wild symbols. Likewise, the “SARDINE” symbol is a scatter symbol, which can cause a credit payout if two or more “SARDINE” symbols in total are displayed in a stationary manner in the variable display parts 21 through 25 irrespective of the activated pay lines. Therefore, the probability that two or more “SARDINE” symbols are stopped will be increased in the high probability mode. Further, “SARDINE” is also a bonus shift symbol to shift the game in the bonus game mode such that the probability to shift the game in the bonus game mode will be increased by increasing the number of “SARDINE” symbols. Therefore, the player may get more payout amount with the same bet number in the high probability mode than in the base game mode if the game shifts (i.e., the payout rate is increased).

Then, the high probability mode is terminated in the game where the predetermined end condition is satisfied. The end condition of the slot machine according to the first embodiment may be (1) in the case that three “SARDINE” symbols are displayed simultaneously in a stationary manner irrespective of the activated pay lines during the game in the high probability mode, (2) in the case that five “WILD” symbols are displayed simultaneously along the activated pay line, (3) in the case that any winning combinations are won fifteen times after shifting to the game in the high probability mode, (4) in the case that the player obtains more than 10,000 coins (or more than 10,000 credits) from starting the first game, (5) in the case that the player obtains more than 1,000 coins (or more than 1,000 credits) after shifting in the high probability mode, (6) in the case that the player has played more than 500 games from starting the first game, (7) in the case that the number of games is more than 20 after shifting in the high probability mode, and (8) in the case that the high probability end condition is met in the lottery conducted upon completion of every game.

Next, each end condition is explained. First, (1) that three “SARDINE” symbols are displayed simultaneously in a stationary manner irrespective of the activated pay lines during the game in the high probability mode and (2) that five “WILD” symbols are displayed simultaneously along the activated pay line can be met if certain symbols are stopped and displayed in the variable display parts 21 through 25. Then, the CPU 50 determines such symbols are displayed in a stationary manner and terminate the high probability mode after the current game ends.

Also, (3) that any winning combinations are won fifteen times after shifting to the game in the high probability mode, (4) that the player obtains more than 10,000 coins (or more than 10,000 credits) from starting the first game, (5) that the player obtains more than 1,000 coins (or more than 1,000 credits) after shifting in the high probability mode, (6) that the player has played more than 500 games from starting the first game, and (7) that the number of games is more than 20 after shifting in the high probability mode can be measured by the counter which counts the number of the winning combinations, the obtained credit number, and the number of the played games from starting the first game or shifting to the high probability mode in the slot machine 1 such that the counter value reaches certain numbers.

Here, the counter value is cumulatively counted in the RAM 52. The counter may include a winning combination counter that counts the number of winning any of the winning combinations after shifting to the high probability mode in the case that the slot machine is currently in the high probability mode, a total acquired credit counter for storing the acquired credit numbers of the player from starting the first game, a high probability mode acquisition counter for storing the credit amount acquired after shifting to the high probability mode if the current game is in the high probability mode, a total game number counter for storing the number of the games the player has played since the player played the first game, a high probability mode game number counter for storing the number of the games after shifting to the high probability mode if the current game is in the high probability mode, and so on. Then, the CPU 50 determines such counter values reach predetermined values and terminate the high probability mode after the current game ends.

Also, (8) that the high probability end condition is met in the lottery conducted upon completion of every game is satisfied depending on the lottery result of the lottery conducted at the end of one game (here, one game is defined as the game process from staring the variable display of the symbols in the variable display parts 21 through 25 to stopping and displaying the symbols) in the game in the high probability mode. FIG. 10 shows a high probability end lottery table utilized in the lottery on this occasion. As shown in FIG. 10, the high probability end lottery table 51C is a lottery table for conducting a lottery based on a random number from “0” to “9” sampled by the sampling circuit 56 upon completion of every game in the high probability mode. Therefore, it is determined by the CPU 50 whether the high probability mode should continue or end based on the selected random number. More specifically, if the sampled random number is from “0” to “8”, the high probability mode continues. On the other hand, if the sampled random number is “9”, the high probability mode is terminated when the current game ends.

Also, in the slot machine 1 of the first embodiment, a lottery to determine whether an additional bet is to be conducted or not until the rotating reel bands are stopped and displayed in a stationary manner. The lottery is conducted by utilizing an additional bet lottery table 51E. FIGS. 13A and 13B show such additional bet lottery tables for this instance.

FIG. 13A shows the additional bet lottery table (additional bet table A) to be referred to if the game is conducted with the MAX bets, and FIG. 13B shows the additional bet lottery table (additional bet table A) to be referred to if the game is conducted with any bet other than the MAX bets.

As shown in FIG. 13A, the additional bet lottery table A indicates that the additional bet is not conducted if the random number is from “0” to “8”. On the other hand, one bet is added to the bet number if the random number is from “9” to “12”. Also, two bets are added to the bet number if the random number is “13” or “14”. Also, three bets are added to the bet number if the random number is “15”.

On the other hand, as shown in FIG. 13B, the additional bet lottery table B indicates that the additional bet is not conducted if the random number is from “0” to “8”. On the other hand, one bet is added to the bet number if the random number is from “9” to “12”. Also, two bets are added to the bet number if the random number is from “13” to “15”.

In this way, if the additional bet lottery table A is referred to, three bets may be added to the bet number. However, if the additional bet lottery table B is referred to, three bets cannot be added to the bet number. That is to say, three bets may be added only when the game is played with the MAX bets.

Here, an explanation of the bet lottery table in another embodiment is added.

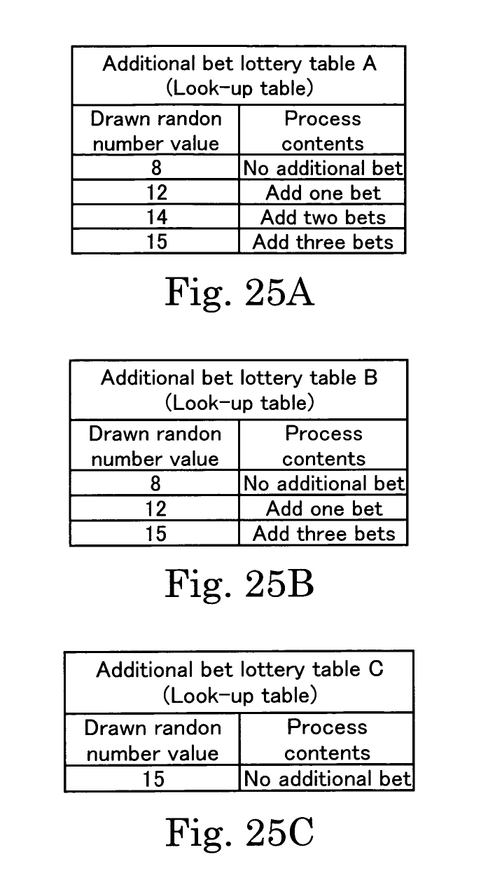

FIG. 25A shows the additional bet lottery table (additional bet table A) to be referred to if the game is conducted with the MAX bets, and FIG. 25B shows the additional bet lottery table (additional bet table A) to be referred to if the game is conducted with any bet other than the MAX bets, and FIG. 25C shows the additional bet lottery table (additional bet table C) to be referred to if the game is conducted in the high probability mode. Here, if the game is conducted in the high probability mode, neither the additional bet lottery table A or the additional bet lottery table B is referred to irrespective of the MAX bets, but the additional bet lottery table C is referred to.

As shown in FIG. 25A, the additional bet lottery table A indicates that the additional bet is not conducted if the random number is from “0” to “8”. On the other hand, one bet is added to the bet number if the random number is from “9” to “12”. Also, two bets are added to the bet number if the random number is “13” or “14”. Also, three bets are added to the bet number if the random number is “15”.

On the other hand, as shown in FIG. 25B, the additional bet lottery table B indicates that the additional bet is not conducted if the random number is from “0” to “8”. On the other hand, one bet is added to the bet number if the random number is from “9” to “12”. Also, two bets are added to the bet number if the random number is from “13” to “15”.

Also, as shown in FIG. 25C, the additional bet lottery table C indicates that the additional bet is not conducted if the random number is from “0” to “15”. That is, the additional bet lottery table C is a bet lottery table having zero percent probability to conduct the additional bet.

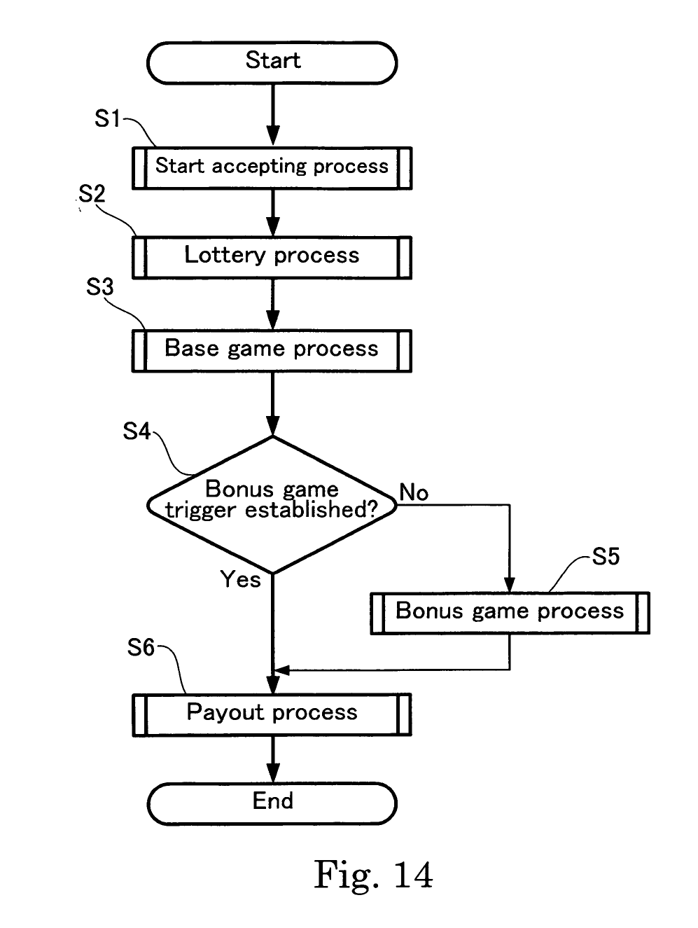

Next, the main process program of the slot machine 1 according to the first embodiment being configured as described above is explained in reference to FIG. 14. FIG. 14 shows a flow chart of the main process program of the slot machine according to the first embodiment. Here, each program shown by flow charts in FIGS. 14 to 20 is stored in the ROM 51 and/or the RAM 52 provided to the slot machine 1 and executed by the CPU 50.

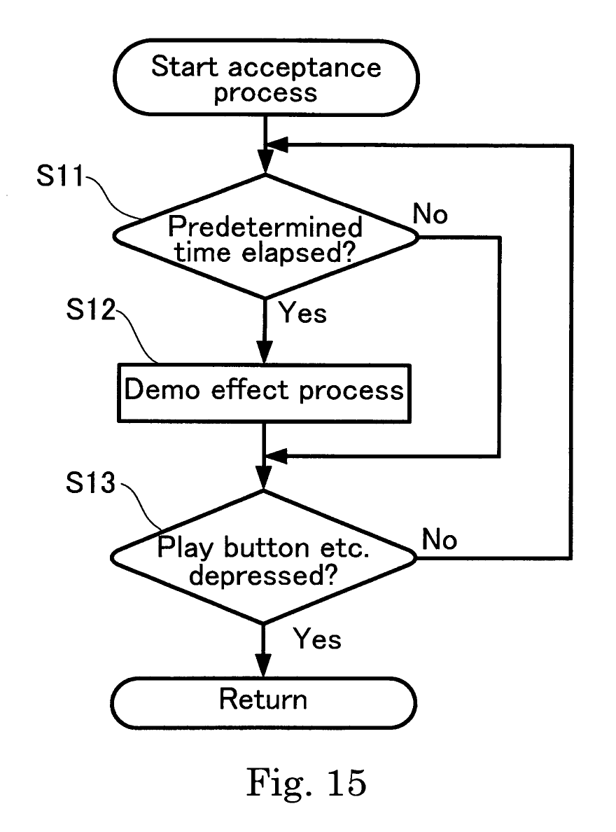

In FIG. 14, firstly in the step (hereafter abbreviated as “S”) 1, a start acceptance process in FIG. 15 to be described later is conducted. This process is a process to receive switch signals outputted from 1-BET switch 57, 3-BET switch 58, 5-BET switch 59, 1-LINE switch 60, 5-LINES switch 61, and 20-LINES switch 62 based on operations of the BET-1-PER button 33, the BET-3-PER-LINE button 34, the BET-5-PER-LINE button 35, the PLAY-1-LINE button 37, the PLAY-5-LINE button 38, and the PLAY-20-LINE button 39, respectively. The game is started when the switch signals outputted from the respective switches.

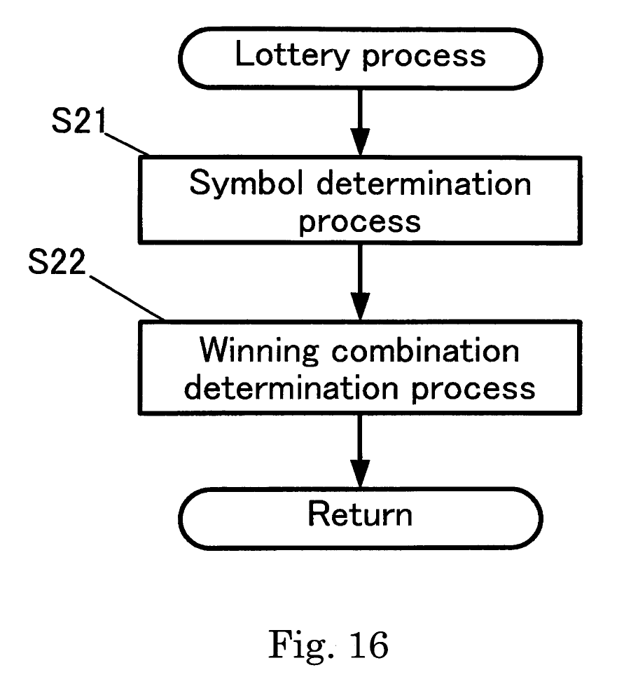

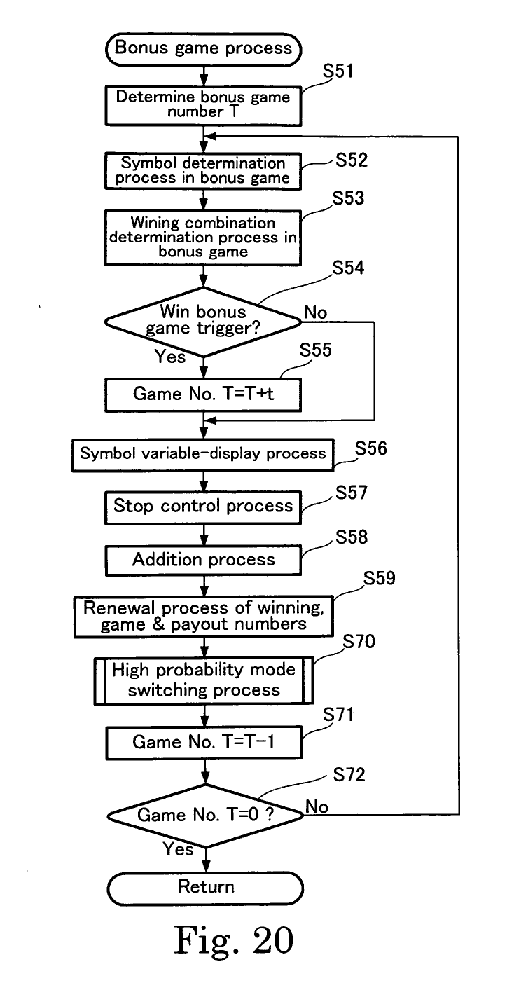

Then, in S2, a lottery process in FIG. 16 to be described later is conducted based on the switch signals outputted from the 1-LINE switch 60, the 5-LINES switch 61, and 20-LINES switch 62. Here, if the bonus game is won (five “SARDINE” symbols (sardine) in total are displayed in a stationary manner in the variable display parts 21 through 25 irrespective of the activated pay lines), the game in the bonus game mode to be described later will be conducted (refer to FIG. 20) after the game in the base game mode ends.

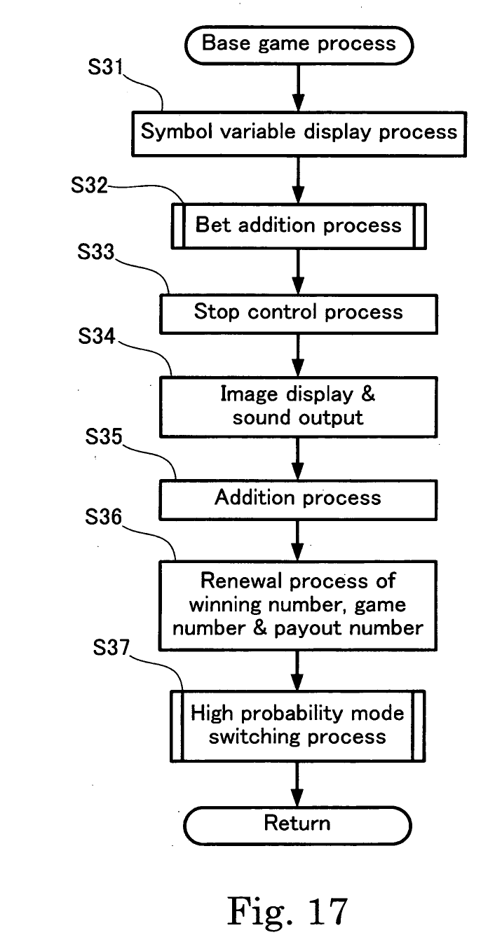

In S3, the base game process in FIG. 17 to be described later is conducted. Thereafter, the program proceeds to S4 to determine whether the bonus game has been won or not. More specifically, in the lottery process of S2, if five “SARDINE” symbols in total are displayed in a stationary manner irrespective of the activated pay lines, the bonus game is won (S4: YES) and the program proceeds to S5. Then, the bonus game process in FIG. 20 to be described later and the program proceeds to S6. On the other hand, in the lottery process of S2, if five “SARDINE” symbols in total are not displayed in a stationary manner irrespective of the activated pay lines, the bonus game is not won (S4: NO) and the program proceeds to S5 and S6. In S6, the credit or the like having been accumulated in the base game process and/or the bonus game process (refer to S35 and S58) is paid out, and the main process program ends.

Next, in the slot machine 1 of the first embodiment, the start acceptance process conducted in S1 is explained in reference to FIG. 15. FIG. 15 is a flow chart of the start acceptance process program in the slot machine of the first embodiment.

In the start acceptance process, the CPU 50 first determines whether a predetermined period of time (e.g., 15 second) has elapsed or not in S11. In this process, if it is determined that the predetermined period of time has not elapsed (S11: NO), the program proceeds to S13 without doing anything. However, if it is determined that the predetermined period of time has elapsed (S11: YES), demo effects are performed on the upper liquid crystal display 3 and the lower liquid crystal display 4 in S12, and the program proceeds to S13

Then, it is determined whether operations of the BET-1-PER-LINE button 33, the BET-3-PER-LINE button 34, the BET-5-PER-LINE button 35, PLAY-1-LINE button 37, PLAY-5-LINES button 38, and PLAY-20-LINES button 38 have been made or not in S13. Here, if it is determined that the operations of the PLAY-1-LINE button 37 and so on have not been made (S13: NO), the program returns to S11 and repeats the processes mentioned above. On the other hand, if it is determined that the operations of the PLAY-1-LINE button 37 and so on have been made (S13: YES), the bet number is set according to the operations even in the middle of the demo effects performance and the pay lines corresponding to the bet number are activated. Then, this routine is completed.

Here, the determination may be made based on not only these operation signals, but also other input signals in the determination process in S13. The CPU 50 in the process of S13 works as setting means for setting the bet number of coins for one game as well as activation means for activating the pay lines according to the bet number

Next, in the slot machine 1 of the first embodiment, the lottery process in S2 is explained in reference to FIG. 16. FIG. 16 is a flow chart of the lottery process program in the slot machine of the first embodiment.

In the lottery process, a symbol determination process is firstly conducted in S21. Here, in the game in the base game mode, symbols that are displayed in a stationary manner along the first pay line L1 are determined for the respective variable display parts 21 through 25. More specifically, five random numbers corresponding to the respective variable display parts 21 through 25 are sampled by the random number sampling circuit 56, and code numbers thereof are determined in reference to the symbol lottery table 51A. Further, the symbols to be displayed in a stationary manner in the respective variable display parts 21 through 25 are determined based on the code numbers and the first reel band 111 through the fifth reel band 115. In this instance, the first reel band 101 is utilized in the base game mode to determine the symbols to be displayed in the variable display part 21. However, in the high probability mode, the sixth reel band 106 is utilized in replacement of the first reel band 101 to determine the symbols to be displayed in a stationary manner.

Then, once the symbols to be displayed in a stationary manner along the activated pay line are determined, the winning determination process in S22 is conducted. Then, the program returns to the main process program and proceeds to the base game process in S3. Here, more specifically, in the winning combination determination process, the winning combination and payout amount thereof are determined in accordance with the symbols determined in S21 and the payout table 51B in FIG. 7. Here, if the slot machine 1 is in the high probability mode, as described before, the symbols are variably and quiescently displayed in the variable display part 21 according to the sixth reel band 106 (refer to FIG. 12) in replacement of the first reel band 101. And the first reel band 101 and the sixth reel band have different symbols (the sixth reel band 106 has more “WILD” and “SARDINE” symbols) such that the probabilities to win the winning combination differ (the probability to win the winning combination is higher in the high probability mode).

Next, the base game process conducted in S3 in the slot machine 1 of the first embodiment is explained in reference to FIG. 17. FIG. 17 is a flow chart of the base game process program in the slot machine of the first embodiment.

In the base game process, symbols are scrolled in the variable display parts 21 through 25 (S31) according to the switch signals outputted from the 1-LINE switch 60, the 5-LINES switch 61 and 20-LINES switch 62 and received in the start acceptance process (S1).

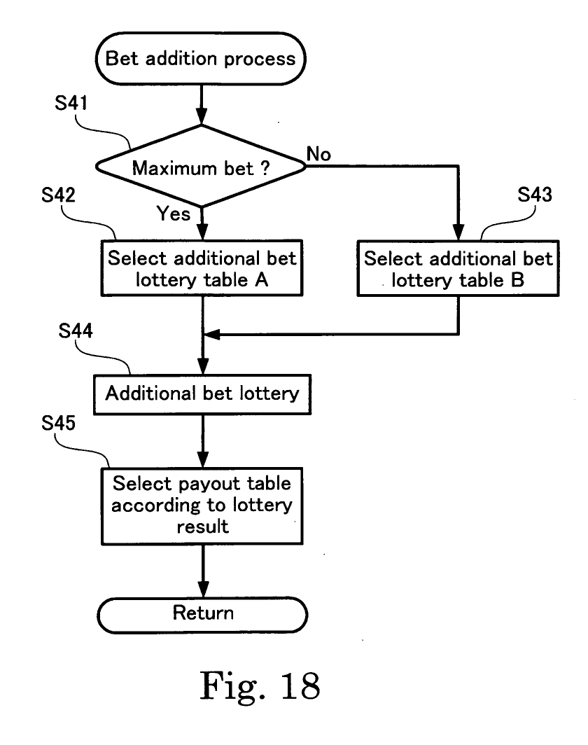

Subsequently, a bet addition process is conducted in S32 to perform a lottery to determine whether the additional bet, which increases the bet number without inserting any additional medals, is conducted or not. Here, the bet addition process is explained in detail later in reference to FIG. 18.

Then, scrolling of the symbols in the variable display areas 21 through 25 is stopped (S33). Subsequently to the process in S33, after a predetermined period of time elapses (e.g., 2 second later), a result of an additional bet lottery (refer to S44 in FIG. 18) in the bet addition process is displayed on the lower liquid crystal display 4 as well as outputted from the speakers 5R, 5L in voice (S34). The lower liquid crystal display 4 and the speakers 5R, 5L work as notification means for notifying the lottery result. Thus, if it is determined to conduct the additional bet, the lottery result is announced by outputting the voice from the speakers and displaying it on the display such that it is possible to provide the player with the feeling of profiting.

Then, after a predetermined period of time elapses (e.g., 2 second later), the credit or the like corresponding to the payout amount being determined based on the payout table 51D in FIG. 7 is added in S35 in accordance with the winning combination of symbols displayed in a stationary manner in the variable display parts 21 through 25 in S33. And the added credit or the like is shown on the lower liquid crystal display 4. Here, the added credit or the like in the process is paid out in the payout process in S6 (refer to FIG. 14). In this instance, the credit or the like corresponding to the payout amount is paid out in reference to the payout table selected in the bet addition process to be described later. Thus, after the reel bands are stopped and the symbols are displayed in a stationary manner, the lottery result of the additional bet is announced (S34). Then, the credit or the like is paid out. Therefore, it is possible to provide the player with joy to find the reel bands stopped in the winning combination and joy to realize the bet number is added in two steps such that it is possible to enhance the amusement.

Subsequently, a renewal process of the number that the winning combinations have been won in S22, the number of the games (including the games both in the base game mode and in the bonus game mode) that the player has played so far, and the payout number of the credit or the like that has been paid out in the payout process in S35 is conducted in S36. Each number value of winning number, game number or payout number is calculated cumulatively according to the continuation feature of the games by the CPU 50 and the results are stored in the RAM 52. Further, if the slot machine 1 is in the high probability mode, the number that the winning combinations have been won after shifting to the game in the high probability mode is also counted such that the winning combination counter stores the counted value. Also, the credit cumulatively acquired after shifting in the high probability mode is counted and stored. Also, the number of games after the shifting in the high probability mode is counted and stored.

Then, a high probability mode switching process to switch between the high probability mode and the normal mode (game mode other than the high probability mode (including base game mode and bonus game mode)) is conducted in S37. Here, the high probability mode switching process will be described later. And after the process in S37, the program returns to the main process program and proceeds to the determination process in S4. In the first embodiment, if it is determined that the symbols displayed in a stationary manner in the variable display parts 21 through 25 include the winning combination, the payout number is determined according to the winning combination as explained above. However, the payout number may be determined according to the combination of symbols displayed in a stationary mode without determining whether the combination of symbols include the winning combination or not. In such an instance, it is possible to set “0” to the payout number corresponding to the combination of symbols that does not match the winning combination. Further, when the medals are paid out in the above process, the hopper driving circuit 70, the hopper 71, payout completion signal circuit 72 and the coin detector 73 work as payout means. On the other hand, the CPU 50 works as the payout means if the credit is paid out.

Subsequently, in the slot machine 1 of the first embodiment, the bet addition process in S32 is explained in reference to FIG. 18. FIG. 18 is a flow chart of the bet addition process program in the slot machine of the first embodiment.

In the bet addition process, it is determined whether the game is conducted with the MAX bets or not in S41 first. In this process, it is determined whether BET-5-PER-LINE button 35 has been operated or not in S13. If it is determined that the game is played with the MAX bets (S41: YES), the additional bet lottery table A (refer to FIG. 13A) is selected (S42) and the process shifts to S44. On the other hand, if it is determined that the game is not played with the MAX bets (S41: NO), the additional bet lottery table B (refer to FIG. 13B) is selected (S43) and the process shifts to S44.

In S44, an additional bet lottery is conducted to determine whether to conduct the additional bet or not. In the additional bet lottery process, the lottery is conducted based on the random number from “0” to “15” being sampled by the sampling circuit 56 by utilizing the additional bet lottery table (refer to FIGS. 13A and 13B) having been selected in S42 or S43. In this instance, the CPU 50 works as lottery means for conducting the lottery to determine whether to conduct the additional bet or not.

Then, the CPU 50 selects the payout table according to the lottery result of the lottery in S44 (S45). More specifically, in the case that the additional bet lottery table A is selected (refer to S42), if the random number is from “0” to “8”, the additional bet is not conducted and the payout table A (refer to FIG. 8A) is selected. And if the sampled random number is from “9” to “12”, one bet is added and the payout table B (refer to FIG. 8B) is selected. And if the sampled random number is “13” or “14”, two bets are added and the payout table C (refer to FIG. 8C) is selected. And if the sampled random number is “15”, three bets are added and the payout table D (refer to FIG. 8D) is selected.

In the case that the additional bet lottery table B (refer to S43) is selected, if the sampled random number is from “0” to “8”, no additional bet is conducted and the payout table A (refer to FIG. 8A) is selected. Also, if the sampled random number is from “9” to “12”, one bet is added and the payout table B (refer to FIG. 8B) is selected. Also, if the sampled random number is from “13” to “15”, two bets are added and the payout table C (refer to FIG. 8C) is selected. In S45, the CPU 50 works as process means for selecting the payout data according to the lottery result. Then, after the process in S45, the program returns to the base game process and proceeds to the stop control process in S33.

Here, in this embodiment, the case that the payout table is selected according to the additional bet lottery result is explained. However, in the present invention, by way of example, the number of medals (game media) according to the lottery result may be paid out if it is determined to conduct the additional bet according to the result of the additional bet lottery. Also, it may be configured that the player can decide to receive either benefit caused by the selection of the payout table or benefit caused by the payout of medals at the player's choice. By configuring the slot machine in this way, it is possible for the player to gain another special benefit than that relating to the stationary display mode of the reels such that the game can provide the player with another kind of fun.

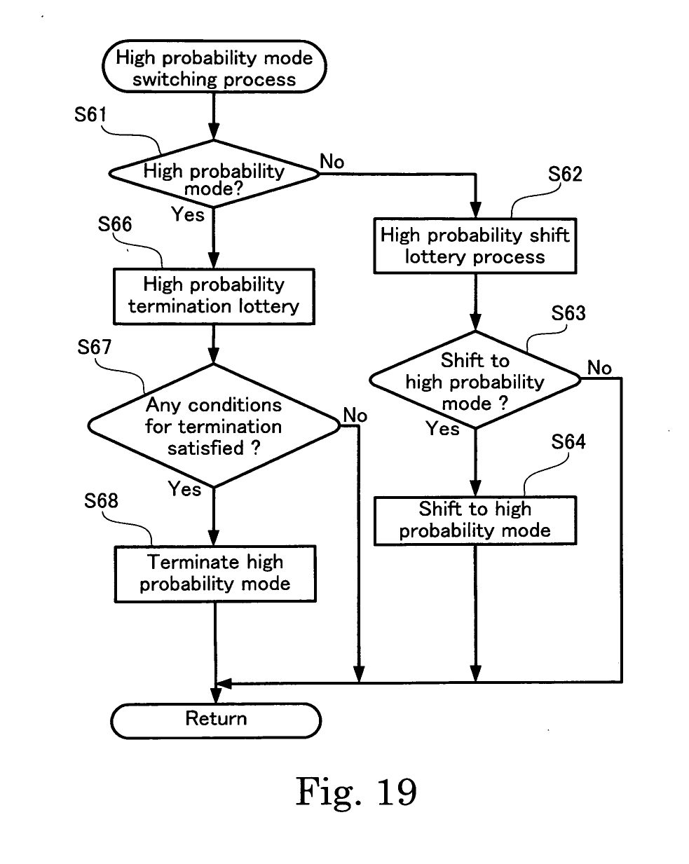

Next, the high probability mode switching process in S37 and S70 (to be described later) is explained in reference to FIG. 19. FIG. 19 is a flow chart of the high probability mode switching process program of the slot machine according to the first embodiment.

In the high probability mode switching process, the CPU 50 determines whether the current slot machine 1 is in the high probability mode or not in S61 first. The slot machine 1 has the base game mode and bonus game mode as well as the high probability mode and the normal mode. And if a predetermined condition is satisfied, these modes are switched with each other.

And if the slot machine 1 is not in the high probability mode (S61: NO), a high probability shift lottery process is conducted to determine whether to shift in the high probability mode or not (S62). In the high probability shift lottery process, the lottery is conducted based on the random number from “0” to “9” sampled by the sampling circuit 56 by utilizing the high probability shift lottery table 51B (refer to FIG. 9).

Then, the CPU 50 determines whether to shift in the high probability mode or not according to the lottery result in S62 (S63). More specifically, if the sampled random number is “9”, the game shifts in the high probability mode while the game continues in the normal mode (not shifts in the high probability mode) if the sampled number is from “0” to “8” (refer to FIG. 9).

Then, if it is determined to shift in the high probability mode (S63: YES), the game shifts in the high probability mode in S64. If the game shifts in the high probability mode, the first reel band 101 is replaced with the sixth reel band 106 (refer to FIG. 12) to display symbols of the reel band in the variable display part 21. Then, the second reel band 102 through the sixth reel band 106 are utilized to display symbols variably and quiescently in the variable display parts 21 through 25. Here, since the sixth reel band 106 includes more “WILD” symbols (alphabetic character) and “SARDINE” symbols (sardine) such that the probability to form any of the winning combinations (refer to FIGS. 8A and 8D) is increased. Therefore, the player can get more payout with the same bet number than in the normal mode if the game shifts in the high probability mode (the payout rate is increased). Then, the high probability mode switching process is completed. On the other hand, if it is determined not to shift in the high probability mode (S63: NO), the high probability mode switching process is completed.

On the other hand, if the slot machine 1 is in the high probability mode (S61: YES), a high probability termination lottery process as one of the termination conditions of the high probability mode is conducted (S66). After the high probability termination lottery process, a selection is made based on the random number from “0” to “9” sampled by the sampling circuit 56 in reference to the high probability termination lottery table 51C (refer to FIG. 10). And if the random number is “9”, one of the termination conditions in S67 to be described later is satisfied.

Then, it is determined whether any one of the termination conditions to terminate the current high probability mode is satisfied or not. In the slot machine 1 of the first embodiment, the termination conditions are as follows:
(1) in the case that three “SARDINE” symbols are displayed simultaneously in a stationary manner irrespective of the activated pay lines,
(2) in the case that five “WILD” symbols are stopped simultaneously along the activated pay line,
(3) in the case that any winning combinations as shown in FIGS. 8A to 8D are won fifteen times after shifting t in the high probability mode,
(4) in the case that the player has obtained more than 10,000 coins (or more than 10,000 credits) from starting the first game,
(5) in the case that the player has obtained more than 1,000 coins (or more than 1,000 credits) after shifting in the high probability mode,
(6) in the case that the player has played more than 500 games from starting the first game,
(7) in the case that the number of games is more than 20 after shifting in the high probability mode, and
(8) in the case that the high probability end condition is met in the lottery conducted upon completion of every game.

More specifically, the conditions (1) and (2) are determined based on the winning combination determined in S22 or S53. And the termination conditions from (3) to (7) are determined based on the counted value stored in the winning combination counter, the total acquired credit counter, the high probability mode acquisition counter, the total game number counter, and the high probability mode game number counter in RAM 52. And the termination condition (8) is determined based on the lottery conducted in S66.

Then, if the CPU 50 has determined that any one of the termination conditions is satisfied (S67: YES), the high probability mode is terminated (S68). When the high probability mode is terminated, the first reel band 101 replaces the sixth reel band 106 and becomes the reel band with the symbols which are displayed in the variable display part 21 such that symbols are variably and quiescently displayed in the variable display parts 21 through 25 with the first reel band 101 through the fifth reel band 105.

On the other hand, if it does not hit any of the termination conditions (S67: NO), the high probability mode continues and the high probability mode switching process is completed. During a period of time from when the game shifts in the high probability mode in S64 as shown in FIG. 19 to when the high probability mode is terminated in S68, the high probability mode is conducted by replacing the first reel band 101 among the first reel band 101 through the fifth reel band 105 to be displayed variably and quiescently in the variable display areas 21 through 25 with the sixth reel band 106. During the period that the game is in the high probability mode, the CPU 50 works as special game execution means for performing the special game having higher probability that the combination of symbols displayed in a stationary manner after the symbols are variably displayed matches any one of the winning combination than in the normal mode.

Further, in the slot machine 1 of the first embodiment, the bonus game process is explained in reference to FIG. 20. FIG. 20 is a flow chart of the bonus game process program in the slot machine of the first embodiment.

In the bonus game process, the game number T of the bonus game is first set. The game number of the bonus game is selected from 10 to 25 by the lottery based on the random number sampled by the random number sampling circuit 56. The set game number T of the bonus game is stored in the RAM 52.

Subsequently, the symbol determination process in the bonus game is conducted in S52. Here, the symbols displayed in a stationary manner along the first pay line L1 are determined for respective variable display parts 21 through 25. More specifically, as described above, five random numbers corresponding to the respective variable display parts 21 through 25 are sampled by the random sampling circuit 56 and code numbers are determined by referring to the symbol lottery table 51A. Further, the symbols to be displayed in a stationary manner in the respective variable display parts 21 through 25 are determined according to the code numbers and the first reel band 111 through the fifth reel band 115.

And when the symbols to be displayed along the activated pay line are determined, the winning combination and payout thereof are determined by referring to the payout table A in FIG. 8A and the symbols determined in S52. In this instance, “SHARK” symbol (shark) is handled as “LOBSTER” symbol (lobster).

Here, if the slot machine 1 is in the high probability mode, as mentioned before, the sixth reel band (refer to FIG. 12) replaces the first reel band 101 and provides the symbols displayed variably and quiescently in the variable display part 21. And since the first reel band 101 and the sixth reel band 106 have different arrays of symbols (the sixth reel band 106 has more “WILD” and “SARDINE” symbols), the probability to win the winning combination differs (the probability to win the winning combination is higher in the high probability mode).

Further, in the winning determination process of S53, it is determined whether a trigger combination to cause the shift to the game in the bonus game mode has been won (five “SARDINE” symbols (sardine) in total are displayed in a stationary manner in the variable display parts 21 through 25 irrespective of the activated pay lines) or not (S54). And if the trigger combination for the bonus game is won (S54: YES), the repetition number t is newly determined by the lottery and the determined repetition number t is added to the current game number T of bonus game repetition (S55). In this way, if the bonus game is won during the game in the bonus game mode, the rest repetition number of the bonus game is increased. More specifically, by way of example, suppose 20 bonus games are won and the game in the bonus game mode is entered. If 17 bonus games are won in the twelfth bonus game, 25 bonus games (20−12+17=25) can be played thereafter. On the other hand, if the trigger combination for the bonus game is not won (S54: NO), the program proceeds to S56.

Then, in a symbol variable process of S56, symbols are automatically scrolled in the variable display parts 21 through 25. And in a stop control process of S57, the symbols being scrolled in the variable display parts 21 through 25 are stopped.

Then, in an addition process of S58, the credit or the like is added, which corresponds to the payout amount determined in accordance with the winning combination displayed in a stationary manner in the variable display areas 21 through 25 by referring to the payout table A in FIG. 8A (in this instance, “SHARK” symbol (shark) is handled as “LOBSTER” symbol (lobster)). The credit or the like is displayed on the lower liquid crystal display 4 as it is added. Here, the credit or the like added during the bonus game process is paid out in the payout process of S6 (refer to FIG. 14) after the bonus game process is completed.

Subsequently, a renewal process of the number that the winning combinations have been won in S53, the number of the games (including the games both in the base game mode and in the bonus game mode) that the player has played so far, and the payout number of the credit or the like that has been paid out in the payout process in S35 is conducted in S59. Each number value of winning number, game number or payout number is calculated cumulatively according to the continuation feature of the games by the CPU 50 and the results are stored in the RAM 52.

Further, if the slot machine 1 is in the high probability mode, the number that the winning combinations have been won after shifting to the game in the high probability mode is also counted such that the winning combination counter stores the counted value. Also, the credit cumulatively acquired after shifting in the high probability mode is counted and stored. Also, the number of games after the shifting in the high probability mode is counted and stored.

Next, the high probability mode switching process (refer to FIG. 19) to switch between the high probability mode and the normal mode (game mode other than the high probability mode (including base game mode and bonus game mode)) is conducted in S70. Then, the program proceeds to S71.

In S71, the CPU 50 reads out the game number T of the bonus game which is stored in the RAM 52 and subtracts “1” from the thus-read game number T. And the processed game number T is again stored in the RAM 52.

Next, in S72, the CPU 50 determines whether the game number T of the bonus game reaches the predetermined number in S51 or not. More specifically, the determination is made depending on whether the game number T stored in the RAM 52 becomes “0” or not. If the game number T is not “0”, that is, it is determined that the number of executing the bonus games does not reach the number determined in S51 (S72: NO), the program returns to S52 and repeats the aforementioned processes. On the other hand, if it is determined that the game number T is “0”, that is, it is determined that the number of executing the bonus games reaches the number determined in S51 (S72: YES), the bonus game process program is terminated.

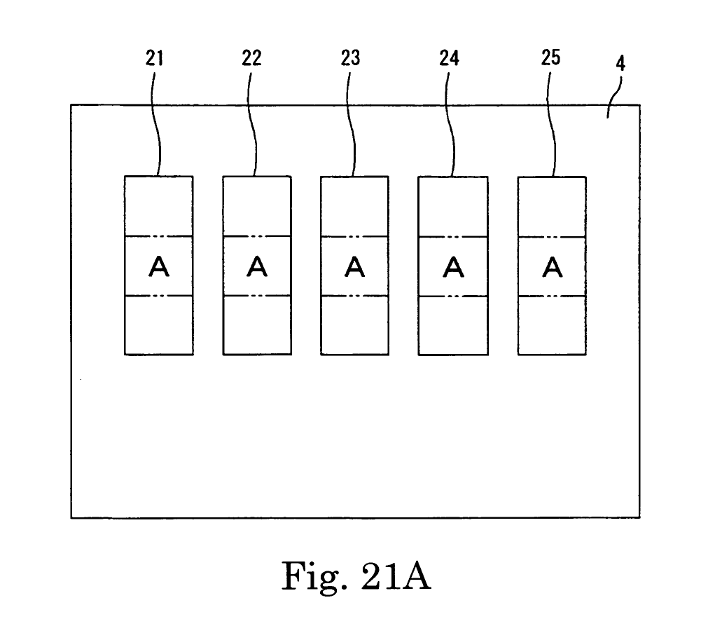

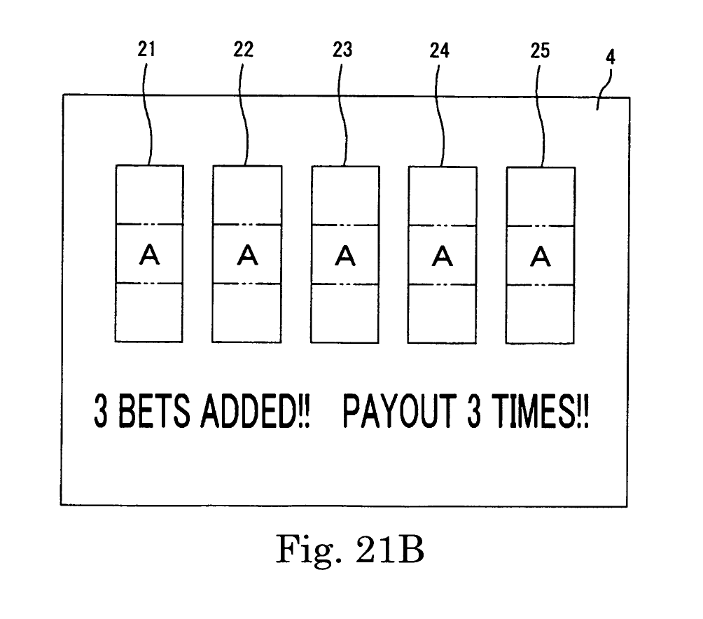

FIGS. 21A and 21B are front views showing images displayed on the lower liquid crystal display. FIG. 21A is a front view showing images displayed on the lower liquid crystal display when the reel bands are displayed in a stationary manner. FIG. 21B is a front view showing images displayed on the lower liquid crystal display after the images shown in FIG. 21A are displayed (e.g., 2 second later). For example, suppose five “A” symbols are displayed along the pay line L1 as shown in FIG. 21A in S33 (refer to FIG. 17). If the additional bet lottery (refer to S32 in FIG. 17) is won (by way of example, 3-bet addition is won in FIG. 21B), “3 BETS ADDED!! PAYOUT 3 TIMES!!” (three bets are added and the payout amount is tripled) is displayed on the lower liquid crystal display as shown in FIG. 21B.

As described above, according to the slot machine 1 of the first embodiment, during a period of time until the variably-displayed symbols of the plurality of reel bands are displayed in a stationary manner, the lottery to determine whether the additional bet is conducted or not. If it is determined to conduct the additional bet, the payout table according to the lottery result is selected from the plurality of payout tables. Thus, since the bet number (additional bet) and the payout are directly associated, the player may have a feeling that the payout amount is changed by the additional bet so as to have more expectation to the game such that a big joy can be given to the player. Also, in the case that it is determined to conduct the additional bet, since the payout table-according to the lottery result is selected from the plurality of payout tables, the player can be provided with amusement that the player's expectation toward the game is increased due to the payout rate based on the selected payout table.

Also, in the slot machine 1 of the first embodiment, when it is determined to conduct the additional bet, if the MAX bets are set, that is, the game is played with the MAX bets, the payout table D only for the MAX bets is selected. Therefore, this can prevent the player from playing the game only without the MAX bets.

In the first embodiment, the case that the payout tables are provided for the respective additional bet numbers is explained, but, by way of example, it is possible to utilize only one payout table and the payout amount can be calculated by a predetermined formula with the payout amount listed in the one payout table. Also, in the first embodiment, the explanation is made for the case in which there are two additional bet lottery tables: one is referred to in the case of MAX bets and the other is referred to in the case of non-MAX bets. However, for example, there may be only one additional bet lottery table such that the winning probabilities for another bet number can be calculated (or converted) by a predetermined formula with the probabilities listed in the one additional bet lottery table.

In the first embodiment, an explanation is made for the case that the control process to change the payout amount in coins for the winning combination according to the additional bet number by winning the additional bet. However, a control process to activate a pay line having not been activated can be conducted. Such a slot machine 1 will be explained below.

### Second Embodiment

A slot machine 1 according to a second embodiment differs in activating a pay line having not been activated according to the additional bet number and having 25 pay lines. However, the slot machine 1 of the second embodiment has substantially the same outer appearance (refer to FIGS. 1 through 3) and circuit configuration (refer to FIGS. 6 and 7). Further, the slot machine 1 of the second embodiment utilizes substantially the same tables except for the payout table and the additional bet lottery table as the slot machine 1 of the first embodiment. It also utilizes substantially the same flow charts except for that of the bet addition process as that of the first embodiment. Therefore, an explanation of the payout table, the additional bet lottery table, and the bet addition process will be made below. And the explanation for the others will be omitted. Here, configuration elements corresponding to the slot machine 1 of the first embodiment will be designated with the same numerals and symbols.

In the slot game (games in the normal game mode and the bonus game mode) of the slot machine 1 of the second embodiment, there are 25 pay lines composed of five areas selected from the respective stationary display areas 211 to 213, 221 to 223, 231 to 233, 241 to 243, and 251 to 253. In each pay line if activated, a payout is provided to the player when specific symbols are aligned along the activated pay line in a specific manner as the symbols are displayed in a stationary manner. Now, each pay line will be explained below. The pay lines of the second embodiment have the pay lines L1 to L20 as described in the first embodiment and the pay line L21 through the pay line L25 (five pay lines). A 21st pay line L22 is formed by the first stationary display area 231; the second stationary display areas 212, 222; and the third stationary display areas 243, 253. A 22nd pay L22 is formed by the first stationary display areas 221, 241; the second stationary display area 212; and the third stationary display areas 233, 253. A 23rd pay L23 is formed by the first stationary display areas 231, 251; the second stationary display area 212; and the third stationary display areas 223, 243. A 24th pay L24 is formed by the first stationary display areas 211, 231; and the third stationary display areas 223, 243, 253. A 25th pay L25 is formed by the first stationary display areas 221, 241, 251; and the third stationary display areas 213, 233.

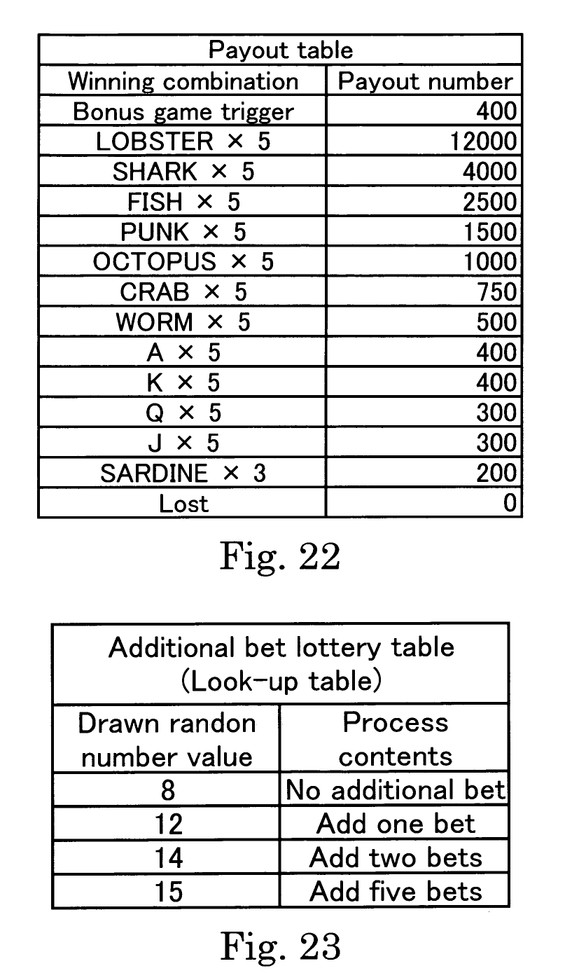

FIG. 22 shows the payout table of the second embodiment. Here, the payout tables shown in FIG. 22 shows payout values in the case that the bet number is “5” before the additional bet. Therefore, in the case that the bet number is “5” before the additional bet, the payout values shown in FIG. 22 are added to the credit. However, in the case that the bet number is other than “5” before the additional bet, that is, the bet number is “N” (N is a natural number less than 5.), the payout values shown in FIG. 22 are multiplied by N/5 and the results are added to the credit.

As shown in FIG. 22, the payout number of “400” is associated with the bonus game trigger in the payout table A. The payout number of “12000” is also associated with “LOBSTER×5”. The payout number of “4000” is also associated with “SHARK×5”. The payout number of “2500” is also associated with “FISH×5”. The payout number of “1500” is also associated with “PUNK×5”. The payout number of “1000” is also associated with “OCTOPUS×5”. The payout number of “750” is also associated with “CRAB×5”. The payout number of “500” is also associated with “WORM×5”. The payout number of “400” is also associated with “A×5”. The payout number of “400” is also associated with “K×5”. The payout number of “300” is also associated with “Q×5”. The payout number of “300” is also associated with “J×5”. The payout number of “200” is also associated with “SARDINE×3”.

FIG. 23 shows the additional bet lottery table. As shown in FIG. 23, the additional bet lottery table indicates that the additional bet is not conducted if the random number is from “0” to “8”. On the other hand, one bet is added to the bet number if the random number is from “9” to “12”. Also, two bets are added to the bet number if the random number is “13” or “14”. Also, five bets are added to the bet number if the random number is “15”.

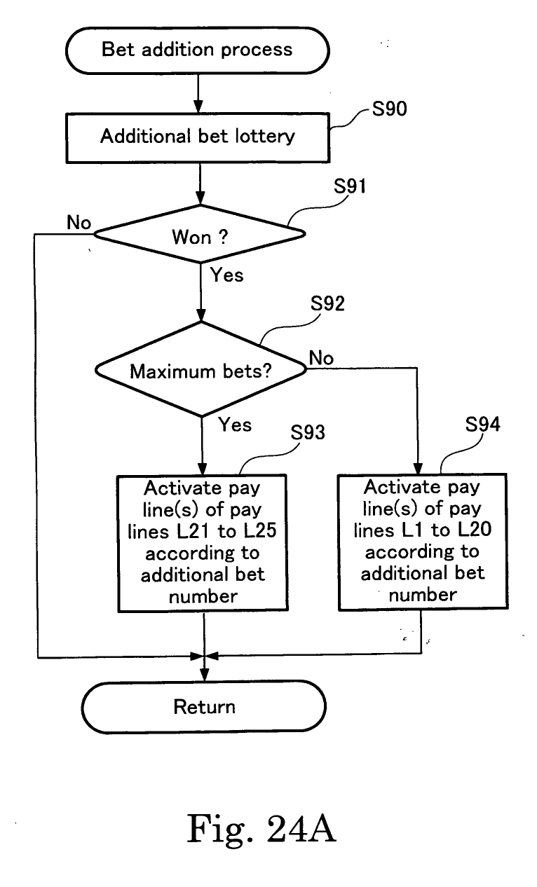

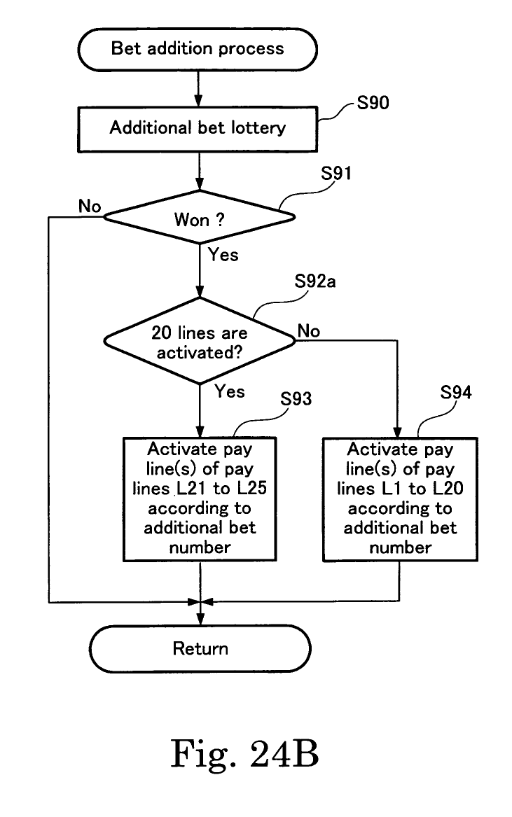

FIG. 24A is a flow chart of the bet addition process program in the slot machine of the second embodiment.

In the bet addition process, an additional bet lottery is conducted first to determine whether to conduct the additional bet or not in S90. In the additional bet lottery process, the lottery is conducted based on the random number from “0” to “15” being sampled by the sampling circuit 56 by utilizing the additional bet lottery table (refer to FIG. 23). In this instance, the CPU 50 works as lottery means for conducting the lottery to determine whether to conduct the additional bet or not.

In S91, it is determined whether the additional bet lottery is won or not. In the process, the CPU 50 determines whether the random number having been sampled in S90 is from “9” to “15” or not. If it is determined to win the additional bet lottery, the program proceeds to S92. If it is determined not to win the additional bet lottery, the program returns to the base game process and proceeds to the stop control process in S33.

It is determined whether the game is conducted with the MAX bets or not in S92. In this process, it is determined whether BET-5-PER-LINE button 35 has been operated or not in S13. If it is determined that the game is played with the MAX bets (S92: YES), pay lines among the pay line L21 through the pay line L25 are activated according to the additional bet number. That is, if the additional bet number is “1”, the pay line L21 is activated. If the additional bet number is “2”, the pay line L21 and the pay line L22 are activated. If the additional bet number is “5”, the pay line L21 through the pay line L25 are activated (S93). On the other hand, if it is determined that the game is not played with the MAX bets (S92: NO), pay lines among the pay L1 though the pay line L20 are activated according to the additional bet number (S94). In the process of S93 or S94, the CPU 50 works as process means for activating one or more pay lines that have not been activated according to the additional bet number. In particular, in S93, the CPU 50 works as process means for conducting a control process to activate the pay line that is to be activated only when the bet number is the MAX bet number. After the process in S93 or S94, the program returns to the base game process and proceeds to the stop control process in S33. If the reel bands are stopped and displayed in the combination of symbols including the winning combination, the credit or the like corresponding to the payout amount is paid out by referring to the payout table shown in FIG. 22.

By way of example, the number of activated pay lines is set as the PLAY-1-LINE button 37, the PLAY-5-LINE button 38, or the PLAY-20-LINE button 39 is depressed in the above embodiment. However, the number of activated pay lines could be automatically set in association with the bet number set by the player (S13 in FIG. 15). For example, the number of activated pay lines may be 20 when the bet number is set at the maximum number (e.g., “5”).

FIG. 24B shows another kind of program utilizing another condition than the MAX bet (maximum bet). It is determined whether the game is conducted with 20 lines (i.e., the maximum number of activated lines in the original setting) or not in S92a. In this process, it is determined whether PLAY-20-LINES button 39 has been operated or not in S13. If it is determined that the game is played with the maximum number of activated lines (S92a: YES), pay lines among the pay line L21 through the pay line L25 are activated according to the additional bet number. That is, if the additional bet number is “1”, the pay line L21 is activated. If the additional bet number is “2”, the pay line L21 and the pay line L22 are activated. If the additional bet number is “5”, the pay line L21 through the pay line L25 are activated (S93). On the other hand, if it is determined that the game is not played with the maximum number of activated lines (S92a: NO), pay lines among the pay line L1 though the pay line L20 are activated according to the additional bet number (S94). In the process of S93 or S94, the CPU 50 works as process means for activating one or more pay lines that have not been activated according to the additional bet number. In particular, in S93, the CPU 50 works as process means for conducting a control process to activate the pay line that is to be activated only when the set number of activated pay lines is the maximum. After the process in S93 or S94, the program returns to the base game process and proceeds to the stop control process in S33. If the reel bands are stopped and displayed in the combination of symbols including the winning combination, the credit or the like corresponding to the payout amount is paid out by referring to the payout table shown in FIG. 22.

As described above, according to the slot machine 1 of the second embodiment, when it is determined to conduct the additional bet, the pay line having not been activated is activated according to the additional bet. Therefore, the player can enjoy the amusement of watching the activated pay line that is added due to the additional bet. Also, when it is determined to conduct the additional bet, a specific pay line (among the pay line L21 through the pay line L25), which is to be activated only with the MAX bets (or MAX lines), is activated in the case that the maximum bet number (or the maximum line number) is set, that is, the game is played with the MAX bets (or MAX lines). Therefore, it may be prevented that the player only plays the game with non-MAX bets (or MAX lines).

In the second embodiment, an explanation is made for the case that the pay line L21 through the pay line L25 are activated when the game is played with the MAX bets. The present invention is not limited to this embodiment. Any from the pay line L1 to the pay line L20 may be activated. Some of the pay line L21 through the pay line L25 and some of the pay line L1 through the pay line L20 may be activated. Also, any of the pay line L21 through the pay line L25 may be activated when the game is not played with the MAX bets.

In the above embodiments, the explanation is made for the case that the additional bet number is “1”, “2”, and “3” for the first embodiment and that the additional bet number is “1”, “2”, and “5” for the second embodiment. However, the additional bet number is not limited according to the present invention.

In the above embodiments, the explanation is made for the case that the control process is conducted to change the payout amounts in coins in the case of winning according to the additional bet number that has been caused by winning the additional bet lottery (the first embodiment), and that the control process is conducted to activate the pay line having not been activated according to the additional bet number (the second embodiment). However, the present invention is not limited to these examples, but a control process to alter the number of game media to be paid out to the player according to the additional bet number. Third Embodiment

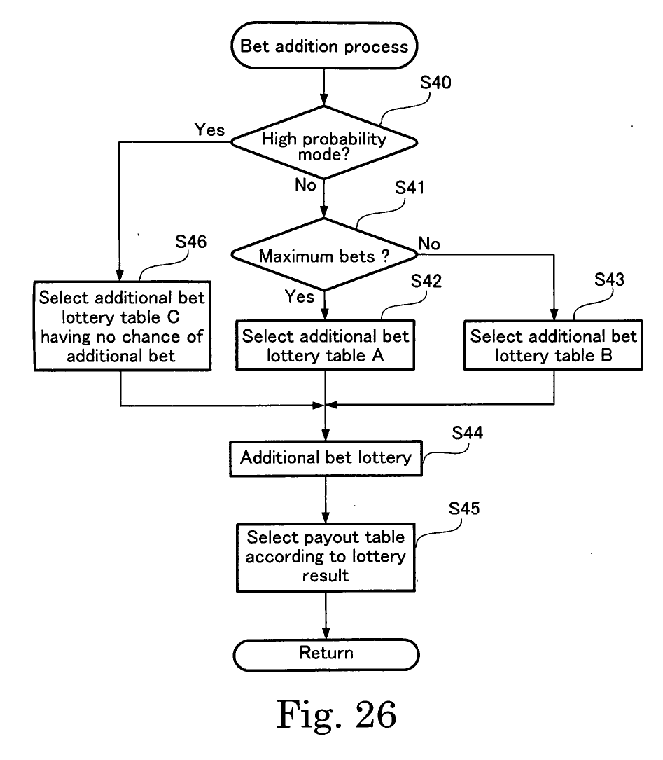

Next, another embodiment will be explained. What is different from the aforementioned embodiments (the first and the second embodiments) will be explained below in reference to FIGS. 25A through 25C and 26.

In the slot machine 1 of the third embodiment, the bet addition process in S32 is explained in reference to FIG. 26. FIG. 26 is a flow chart of the additional bet process program in the slot machine of the third embodiment.

In the additional bet process, the CPU 50 determines whether the current slot machine 1 is in the high probability mode or not in S40 first.

If the slot machine 1 is in the high probability mode (S40: YES), an additional bet lottery table C having zero (0) percent probability to the additional bet (refer to FIG. 25C) is selected (S46) and the program proceeds to S44. In S46, the CPU 50 works as inhibit process means for precluding a control process of the payout of the game media while the player is playing the game in the high probability mode as a special game. On the other hand, if it is not in the high probability mode (S40: NO), the program proceeds to S41.

In S41, it is determined whether the game is conducted with the MAX bets or not. In this process, it is determined whether BET-5-PER-LINE button 35 has been operated or not in S13. If it is determined that the game is played with the MAX bets (S41: YES), the additional bet lottery table A (refer to FIG. 25A) is selected (S42) and the process shifts to S44. On the other hand, if it is determined that the game is not played with the MAX bets (S41: NO), the additional bet lottery table B (refer to FIG. 25B) is selected (S43) and the process shifts to S44.

In S44, the additional bet lottery is conducted to determine whether to conduct the additional bet or not. In the additional bet lottery process, the lottery is conducted based on the random number from “0” to “15” being sampled by the sampling circuit 56 by utilizing the additional bet lottery table (refer to FIGS. 25A through 25C) having been selected in S42, S43 or S46. In this instance, the CPU 50 works as lottery means for conducting the lottery to determine whether to conduct the additional bet or not.

Then, the CPU 50 selects the payout table according to the lottery result of the lottery in S44 (S45). More specifically, in the case that the additional bet lottery table A is selected (refer to S42), if the random number is from “0” to “8”, the additional bet is not conducted and the payout table A (refer to FIG. 8A) is selected. And if the sampled random number is from “9” to “12”, one bet is added and the payout table B (refer to FIG. 8B) is selected. And if the sampled random number is “13” or “14”, two bets are added and the payout table C (refer to FIG. 8C) is selected. And if the sampled random number is “15”, three bets are added and the payout table D (refer to FIG. 8D) is selected.

In the case that the additional bet lottery table B (refer to S43) is selected, if the sampled random number is from “0” to “8”, no additional bet is conducted and the payout table A (refer to FIG. 8A) is selected. Also, if the sampled random number is from “9” to “12”, one bet is added and the payout table B (refer to FIG. 8B) is selected. Also, if the sampled random number is from “13” to “15”, two bets are added and the payout table C (refer to FIG. 8C) is selected.

Also, if the additional bet lottery table C (refer to S46) is selected, no additional bet is conducted and the payout table A (refer to FIG. 8A) is selected. In S45, the CPU 50 works as process means for conducting a control process (process to select the payout data according to the lottery result) about the payout of game media according to the lottery result. Then, after the process in S45, the program returns to the base game process and proceeds to the stop control process in S33.

Here, in the third embodiment, the case that the payout table is selected according to the additional bet lottery result is explained. However, in the present invention, by way of example, the number of medals (game media) according to the lottery result may be paid out if it is determined to conduct the additional bet according to the result of the additional bet lottery. Also, it may be configured that the player can decide to receive either benefit caused by the selection of the payout table or benefit caused by the payout of medals at the player's choice. By configuring the slot machine in this way, it is possible for the player to gain another special benefit than that relating to the stationary display mode of the reels such that the game can provide the player with another kind of fun.

Here, the high probability mode switching process to be conducted in S37 and S70 is the process explained in reference to FIG. 19.

In the slot machine 1 of the third embodiment, while the game in the high probability mode and in the bonus game mode (in the high probability bonus game mode) is played, the additional bet lottery table C that has zero percent probability to conduct the additional bet is selected among the three kinds of additional bet lottery tables. In such a way, it is not necessary to change the bet lottery as the process itself. Since only the additional bet lottery table is changed, it is not necessary to conduct the program change or the like in order to prevent winning the bet lottery in the high probability mode.

In the third embodiment, the case that the payout tables are provided for the respective additional bet numbers is explained, but, by way of example, it is possible to utilize only one payout table and the payout amount can be calculated by a predetermined formula with the payout amount listed in the one payout table.

Also, in the third embodiment, the explanation is made for the case in which the game program utilizes the additional bet lottery table to be referred to in the high probability mode and the other additional bet lottery tables to be referred to in the other modes than the high probability mode. However, for example, the game program may have only one additional bet lottery table and the probabilities to win the additional bet which are listed in the one additional bet lottery table may be made zero percent if the game is in the high probability mode. In such a case, it is necessary to change (or convert) only the probabilities to win the additional bet so as to avoid a big design change such as the program change in order to prevent winning the additional bet in the high probability mode. Alternatively, a control process can be executed if the game is in the high probability mode in order to preclude the bet lottery to determine whether to conduct the additional bet or not.

In the third embodiment, the explanation is made for the case that the control process is conducted to change the payout amounts in coins in the case of winning according to the additional bet number that has been caused by winning the additional bet lottery. The present invention is not limited to this instance. For example, a control process to activate a pay line that has not been activated may be carried out in accordance with the additional bet number.

### Fourth Embodiment

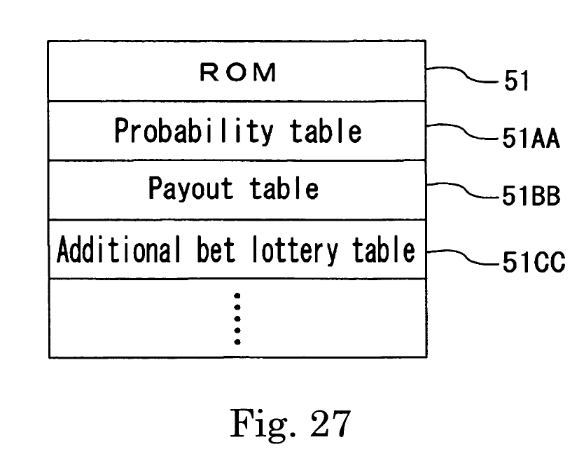

Next, another embodiment will be explained. What is different from the aforementioned embodiments will be explained below in reference to FIGS. 5 and 27.

The CPU 50 is connected to a LED 78 via a LED driving circuit 77. The LED 78 is controlled by the LED driving circuit 77 to blink based on a driving signal transmitted from the CPU 50 as various kinds of effects are performed on the front face of the slot machine on which many LED elements are provided. In particular, in the slot machine 1 of the fourth embodiment, the LED 78 is lit to enhance the effects during the bonus game mode to be described later.

Also, the CPU 50 is connected to a sound output circuit 79 and speakers 5L, 5R such that the speakers 5L, 5R generate voices and effect sounds when various effects are performed in accordance with an output signal from the sound output circuit 79.

Also, as shown in FIG. 27, the ROM 51 stores a probability table 51AA, a payout table 51BB, and an additional bet lottery table 51CC.

FIGS. 28A and 28B show examples of probability tables in the case of 20 LINES. FIG. 28A shows a probability table A to be referred to when the additional bet lottery is not won and FIG. 28B shows a probability table B to be referred to when the additional bet lottery is won.

As shown in FIGS. 28A and 28B, the random number values to be used in the probability tables are from 0 to 65535. Thus, the number of the random numbers is 65536. Each numeric value is associated with the winning combination as a winning mode. Here, in the figures, each winning probability is listed for each winning mode.

The winning combination is determined according to the probability table A shown in FIG. 28A and the details are as follows. A trigger to the bonus game is won at the probability of 120/65536. In this case, five “SARDINE” symbols are simultaneously displayed in a stationary manner irrespective of the activated pay line to form the winning mode so as to switch the game into the bonus game mode. The “LOBSTER” winning combination is won at the probability of 40/65536. In this case, five “LOBSTER” symbols (lobster) are displayed in a stationary manner along the activated pay line to form the winning mode. The “SHARK” winning combination is won at the probability of 120/65536. In this case, five “SHARK” symbols (shark) are displayed in a stationary manner along the activated pay line to form the winning mode. Likewise, the probabilities are shown as follows: the “FISH” winning combination at the probability of 200/65536, the “PUNK” winning combination at the probability of 400/65536, the “OCTOPUS” winning combination at the probability of 600/65536, the “CRAB” winning combination at the probability of 800/65536, the “WORM” winning combination at the probability of 1000/65536, the “A” winning combination at the probability of 1200/65536, the “K” winning combination at the probability of 1200/65536, the “Q” winning combination at the probability of 1200/65536, and the “J” winning combination at the probability of 1200/65536. If five symbols constituting the winning combination are displayed along the activated pay line, this combination is the winning combination.

Also, the “SARDINE” combination is at the probability of 800/65536 such that three “SARDINE” symbols are displayed in a stationary manner irrespective of the activated pay line. On the other hand, the “Lost” combination is made at the probability of 56656/65536 such that any combinations of symbols other than the winning combinations described above are displayed in a stationary manner.

FIG. 28B shows a probability table B. In the probability table B, the probability to win the “BONUS GAME TRIGGER” combination is zero (0), and the probability to get “Lost” combination is 56776/65536. The other probabilities to win the other winning combination are the same as in the probability table A.

In the slot machine 1, after the lottery to determine the winning combination, a lottery to determine a stationary display combination of symbols (a lottery to determine a code number) is conducted so as to display the winning combination of symbols is displayed in a stationary manner. And the symbols are displayed in a stationary manner according to the lottery result. Here, FIGS. 28A and 28B show the probability tables in the case of 20 LINES, each winning combination other than “Lost” is in proportion to the number of the activated pay lines in the slot machine 1. For example, in the probability table in the case of 1 LINE, the probabilities to win the winning combinations other than “Lost” are set to one-twentieth ( 1/20) of those in the probability table in the case of 20 LINES.

Next, the winning combination and a payout thereof are explained in reference to FIGS. 8A to 8D in the case that the game in the base game mode and the game in the bonus game mode are conducted by utilizing the five variable display parts 21 through 25 in the slot machine.

FIG. 8A shows a payout table (payout table A) to be referred to without any additional bet, FIG. 8B shows a payout table (payout table B) to be referred to with one additional bet, FIG. 8C shows a payout table (payout table C) to be referred to with two additional bets, and FIG. 8D shows a payout table (payout table D) to be referred to with three additional bets.

Here, the payout tables shown in FIGS. 8A to 8D show payout values in the case that the bet number is “5” before the additional bet. Therefore, in the case that the bet number is “5” before the additional bet, the payout values shown in FIGS. 8A to 8D are added to the credit. However, in the case that the bet number is other than “5” before the additional bet, that is, the bet number is “N” (N is a natural number less than 5.), the payout values shown in FIGS. 8A to 8D are multiplied by N/5 and the results are added to the credit.

As shown in FIG. 8A, the payout number of “400” is associated with the bonus game trigger in the payout table A. The payout number of “12000” is also associated with “LOBSTER×5”. The payout number of “4000” is also associated with “SHARK×5”. The payout number of “2500” is also associated with “FISH×5”.

The payout number of “1500” is also associated with “PUNK×5”. The payout number of “1000” is also associated with “OCTOPUS×5”. The payout number of “750” is also associated with “CRAB×5”. The payout number of “500” is also associated with “WORM×5”. The payout number of “400” is also associated with “A×5”. The payout number of “400” is also associated with “K×5”. The payout number of “300” is also associated with “Q×5”. The payout number of “300” is also associated with “J×5”. The payout number of “200” is also associated with “SARDINE×3”.

Further, as shown in FIG. 8B, the payout number for each winning combination is listed in the payout table B. The payout number for each winning combination except “Lost” is 1.5 times as many as the corresponding payout number listed in the payout table A (refer to FIG. 8A).

Further, as shown in FIG. 8C, the payout number for each winning combination is listed in the payout table C. The payout number for each winning combination except “Lost” is twice as many as the corresponding payout number listed in the payout table A (refer to FIG. 8A).

Further, as shown in FIG. 8D, the payout number for each winning combination is listed in the payout table D. The payout number for each winning combination except “Lost” is three times as many as the corresponding payout number listed in the payout table A (refer to FIG. 8A).

Next, the bonus game is explained. If five bonus trigger symbols appear (are displayed in a stationary manner) at the same time in the variable display parts 21 through 25 irrespective of the activated pay lines in this slot machine 1, the game may shift to the bonus game.

Here, the bonus game is the game in the bonus game mode to be started if a specific condition is satisfied during the game in the base game mode and generally tends to be beneficial to the player. If the game shifts to the bonus game (or the game in the bonus game mode) in this instance, fifteen (15) to twenty five (25) games may be played consecutively and automatically without betting any credits or the like (so-called free game). The number of games is determined according to the lottery result when the game shifts to the bonus game.

Here, the bet number and the number of the activated pay lines at the point of shifting to the bonus game are used in the bonus game. Also, the winning combinations and payouts thereof are the same as those of the game in the base game mode described above. However, “SHARK” symbol (shark) is handled as “LOBSTER” symbol (lobster) and if five “SARDINE” symbols in total appear (are displayed in a stationary manner), it is possible to shift to the game in the bonus game mode again. Here, as shown in FIGS. 8A to 8D, the “LOBSTER” symbol (lobster) is associated with a higher number of payouts than that of the “SHARK” symbol (shark) in the case of winning such that it is likely for the player to obtain a large number of credits or the like without consuming the owned credits.

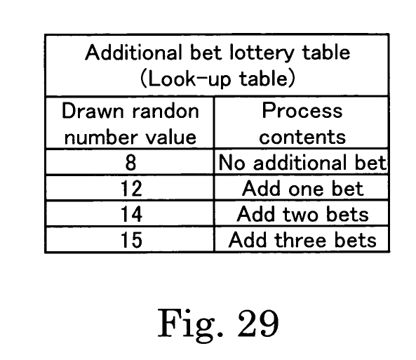

Also, in the slot machine 1 of the fourth embodiment, a lottery to determine whether an additional bet is to be conducted or not until the rotating reel bands are stopped and displayed in a stationary manner. The lottery is conducted by utilizing an additional bet lottery table 51CC. FIG. 29 shows an additional bet lottery table for this instance.

FIG. 29 shows an example of the additional bet lottery table. As shown in FIG. 29, the additional bet is not conducted if the random number is from “0” to “8”. On the other hand, one bet is added to the bet number if the random number is from “9” to “12”. Also, two bets are added to the bet number if the random number is “13” or “14”. Also, three bets are added to the bet number if the random number is “15”.

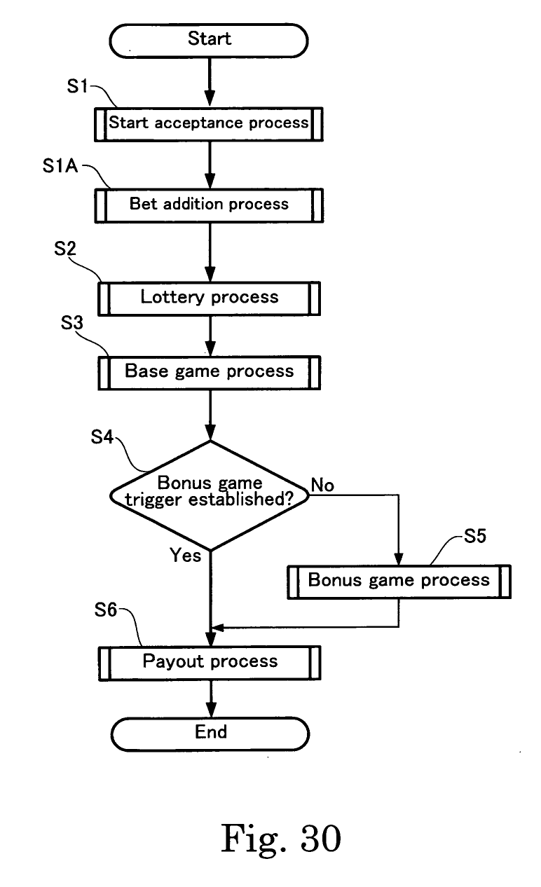

Next, the main process program of the slot machine 1 according to the fourth embodiment being configured as described above is explained in reference to FIG. 30. FIG. 30 shows a flow chart of the main process program of the slot machine according to the first embodiment. Here, each program shown by flow charts in FIGS. 30 to 34 is stored in the ROM 51 and/or the RAM 52 provided to the slot machine 1 and executed by the CPU 50.

In FIG. 30, firstly in S1, a start acceptance process in FIG. 15 is conducted. This process is a process to receive switch signals outputted from 1-BET switch 57, 3-BET switch 58, 5-BET switch 59, 1-LINE switch 60, 5-LINES switch 61, and 20-LINES switch 62 based on operations of the BET-1-PER button 33, the BET-3-PER-LINE button 34, the BET-5-PER-LINE button 35, the PLAY-1-LINE button 37, the PLAY-5-LINE button 38, and the PLAY-20-LINE button 39, respectively. The game is started when the switch signals outputted from the respective switches.

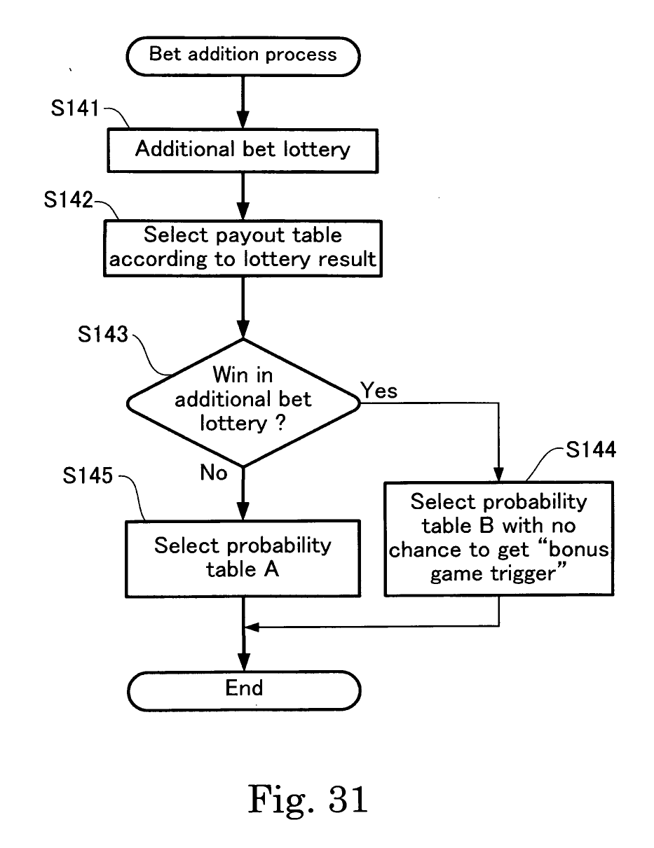

Subsequently, in S1A, a bet addition process is conducted to perform a lottery to determine whether to conduct the additional bet or not. Here, the additional bet process will be explained in detail later in reference to FIG. 31.

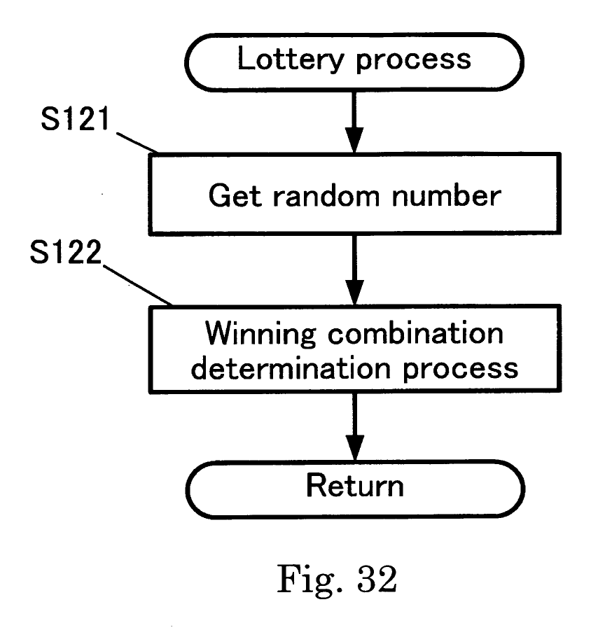

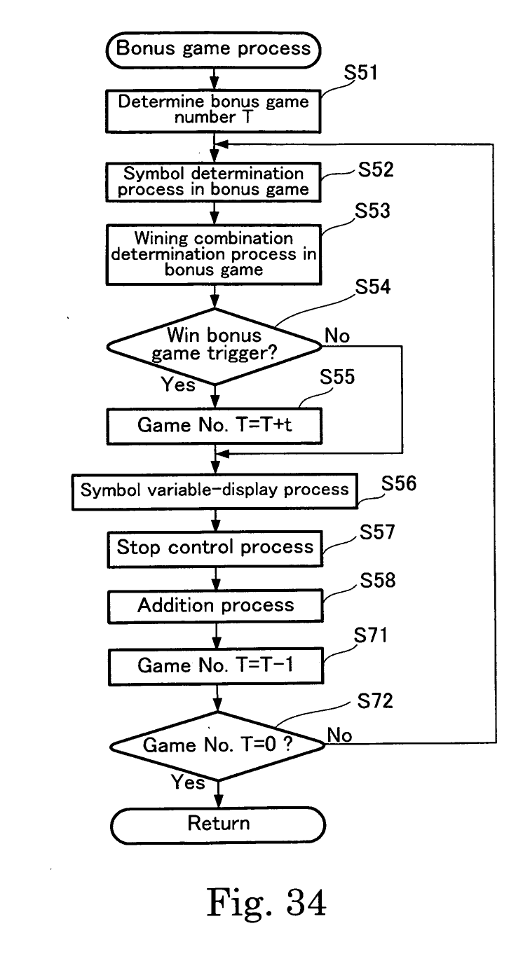

Then, in S2, a lottery process in FIG. 32 to be described later is conducted based on the switch signals outputted from the 1-LINE switch 60, the 5-LINES switch 61, and 20-LINES switch 62. Here, if the bonus game is won (five “SARDINE” symbols (sardine) in total are displayed in a stationary manner in the variable display parts 21 through 25 irrespective of the activated pay lines), the game in the bonus game mode to be described later will be conducted after the game in the base game mode ends (refer to FIG. 34).

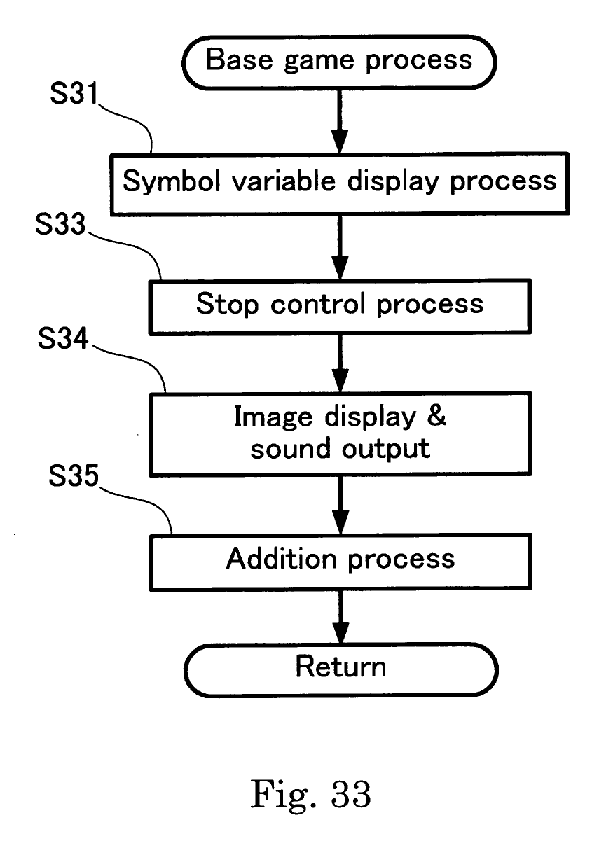

In S3, the base game process in FIG. 33 to be described later is conducted. Thereafter, the program proceeds to S4 to determine whether the bonus game has been won or not. More specifically, in the lottery process of S2, if five “SARDINE” symbols in total are displayed in a stationary manner irrespective of the activated pay lines, the bonus game in FIG. 34 is won (S4: YES) and the program proceeds to S5 to conduct a bonus game process in FIG. 34 to be described later. Then, the program proceeds to S6. On the other hand, in the lottery process of S2, if five “SARDINE” symbols in total are not displayed in a stationary manner irrespective of the activated pay lines, the bonus game is not won (S4: NO) and the program proceeds to S6. In S6, the credit or the like having been accumulated in the base game process and/or the bonus game process (refer to S35 and S58) is paid out, and the main process program ends.

Subsequently, in the slot machine 1 of the fourth embodiment, the start acceptance process conducted in S1 is explained in reference to FIG. 15. FIG. 15 is a flow chart of the start acceptance process program in the slot machine of the fourth embodiment.

In the start acceptance process, the CPU 50 first determines whether a predetermined period of time (e.g., 15 second) has elapsed or not in S11. In this process, if it is determined that the predetermined period of time has not elapsed (S11: NO), the program proceeds to S13 without doing anything. However, if it is determined that the predetermined period of time has elapsed (S11: YES), demo effects are performed on the upper liquid crystal display 3 and the lower liquid crystal display 4 in S12, and the program proceeds to S13.

Then, it is determined whether operations of the PLAY-1-LINE button 37, the PLAY-5-LINES button 38, and the PLAY-20-LINES button 39 have been made or not in S13. Here, if it is determined that the operations of the PLAY-1-LINE button 37 and so on have not been made (S13: NO), the program returns to S11 and repeats the processes mentioned above. On the other hand, if it is determined that the operations of the PLAY-1-LINE button 37 and so on have been made (S13: YES), this routine is completed even in the middle of the demo effects performance.

Here, the determination may be made based on not only these operation signals, but also other input signals in the determination process in S13. The CPU 50 in the process of S13 works as setting means for setting the bet number of coins for one game.

Next, in the slot machine 1 of the fourth embodiment, a bet addition process in SA is explained in reference to FIG. 31. FIG. 31 is a flow chart of the bet addition process program in the slot machine of the fourth embodiment.

In the bet addition process, an additional bet lottery is conducted first to determine whether to conduct the additional bet or not in S141. In the additional bet lottery process, the lottery is conducted based on the random number from “0” to “15” being sampled by the sampling circuit 56 by utilizing the additional bet lottery table (refer to FIG. 29). In this instance, the CPU 50 works as lottery means for conducting the lottery to determine whether to conduct the additional bet or not.

Next, in S142, the CPU 50 selects the payout table according to a result of the lottery in S141.

More specifically, if the random number is from “0” to “8”, the additional bet is not conducted and the payout table A (refer to FIG. 8A) is selected. And if the sampled random number is from “9” to “12”, one bet is added and the payout table B (refer to FIG. 8B) is selected. And if the sampled random number is “13” or “14”, two bets are added and the payout table C (refer to FIG. 8C) is selected. And if the sampled random number is “15”, three bets are added and the payout table D (refer to FIG. 8D) is selected. In S142, the CPU 50 works as process means for selecting the payout data according to the lottery result.

Here, in the fourth embodiment, the case that the payout table is selected according to the additional bet lottery result is explained. However, in the present invention, by way of example, the number of medals (game media) according to the lottery result may be paid out if it is determined to conduct the additional bet according to the result of the additional bet lottery. Also, either benefit by the selection of the payout table or benefit by the payout of medals may be selected by the player at the player's choice. By configuring the slot machine in this way, it is possible for the player to gain another special benefit than that relating to the stationary display mode of the reels such that the game can provide the player with another kind of fun.

Next, it is determined whether the additional bet is won or not (S143). In this process, the CPU 50 determines whether the random number sampled in S141 is from “9” to “15” or not. If it is determined to win the additional bet lottery (S143: YES), the probability table B with zero percent probability to “BONUS GAME TRIGGER” is selected (S144). On the other hand, if it is determined not to win the additional bet lottery (S143: NO), the probability table A is selected (S144). And after the process in S144 or S145, the program returns to the main process and proceeds to the lottery process in S2.

In S143 through S145, the CPU 50 works as inhibit winning means for precluding that the winning combination that is predetermined as a condition to shift the game into the special game mode (bonus game mode) is displayed in a stationary manner by stopping the plurality of reel bands if it is determined to conduct the additional bet.

Next, in the slot machine 1 of the first embodiment, the lottery process in S2 is explained in reference to FIG. 32. FIG. 32 is a flow chart of the lottery process program in the slot machine of the first embodiment.

In the lottery process, one random number is sampled from 0 to 65535 by the random number sampling circuit 56 first. Next, based on the sampled random number, the winning combination as the winning mode is determined (S122) based on the random number by referring to the probability table selected in S144 or 145 (refer to FIG. 31). In this instance, if the probability table B is selected, the probability to win the “BONUS GAME TRIGGER” combination is zero (0%) such that the game will not shift into the bonus game mode.

After the lottery to determine the winning combination is conducted, a lottery to determine the stationary display combination of symbols (or lottery to determine the code number) is conducted in order to display the symbols constituting the winning combination are displayed in a stationary manner.

Next, the base game process conducted in S3 in the slot machine 1 of the fourth embodiment is explained in reference to FIG. 33. FIG. 33 is a flow chart of the base game process program in the slot machine of the fourth embodiment.

In the base game process, symbols are scrolled in the variable display parts 21 through 25 (S31) according to the switch signals outputted from the 1-LINE switch 60, the 5-LINES switch 61 and 20-LINES switch 62 and received in the start acceptance process (S1). Thereafter, scrolling the symbols in the variable display parts 21 through 25 is stopped (S33). Subsequently to the process in S33, after a predetermined period of time elapses (e.g., 2 second later), a result of an additional bet lottery (refer to S141 in FIG. 31) in the bet addition process is displayed on the lower liquid crystal display 4 as well as outputted from the speakers 5R, 5L in voice (S34). The lower liquid crystal display 4 and the speakers 5R, 5L work as notification means for notifying the lottery result. Thus, if it is determined to conduct the additional bet, the lottery result is announced by outputting the voice from the speakers and displaying it on the display such that it is possible to provide the player with the feeling of profiting.

Then, after a predetermined period of time elapses (e.g., 2 second later), the payout amount corresponding to the stationary display mode in the variable display parts 21 through 25 is determined by referring to the payout table (refer to FIGS. 8A to 8D), and the number of medals, credits or the like equivalent to the determined payout amount is added such that the lower liquid crystal display 4 displays the number of medals, credits or the like (S35). Here, the added credit or the like in the process is paid out in the payout process in S6 (refer to FIG. 30). And after such payout process, the program returns to the main process and proceeds to a determination process in S4.

Further, in the slot machine 1 of the fourth embodiment, the bonus game process is explained in reference to FIG. 34. FIG. 34 is a flow chart of the bonus game process program in the slot machine of the fourth embodiment.

In the bonus game process, the game number T of the bonus game is first set. The game number of the bonus game is selected from 10 to 25 by the lottery based on the random number sampled by the random number sampling circuit 56. The set game number T of the bonus game is stored in the RAM 52.

Subsequently, a random number is sampled in S52 and the winning combination is determined in S53. These processes are quite similar to those in S121 and S122.

Further, in the winning determination process of S53, it is determined whether a trigger combination to cause the shift to the game in the bonus game mode has been won (five “SARDINE” symbols (sardine) in total are displayed in a stationary manner in the variable display parts 21 through 25 irrespective of the activated pay lines) or not (S54). And if the trigger combination for the bonus game is won (S54: YES), the repetition number t is newly determined by the lottery and the determined repetition number t is added to the current game number T of bonus game repetition (S55). In this way, if the bonus game is won during the game in the bonus game mode, the rest repetition number of the bonus game is increased. More specifically, by way of example, suppose 20 bonus games are won and the game in the bonus game mode is entered. If 17 bonus games are won in the twelfth bonus game, 25 bonus games (20−12+17=25) can be played thereafter. On the other hand, if the trigger combination for the bonus game is not won (S54: NO), the program proceeds to S56.

In a symbol variable process of S56, symbols are automatically scrolled in the variable display parts 21 through 25. And in a stop control process of S57, the symbols being scrolled in the variable display parts 21 through 25 are stopped.

In an addition process of S58, it is determined whether the stationary display mode in the variable display parts 21 through 25 is the winning combination or not. If it is determined to be the winning mode, the payout amount is determined by referring to the probability table A (FIG. 28A). The number of medals, credits or the like equivalent to the determined payout amount are added and displayed on the lower liquid crystal display 4 (S58). Here, the credit or the like added during the bonus game process is paid out in the payout process of S6 (refer to FIG. 32) after the bonus game process is completed. In the bonus game, “SHARK” symbol (shark) is handled as “LOBSTER” symbol (lobster) when the winning combination is determined by referring to the probability table.

Subsequently, in S71, the CPU 50 reads out the game number T of the bonus game which is stored in the RAM 52 and subtracts “1” from the thus-read game number T. And the processed game number T is again stored in the RAM 52.

Next, in S72, the CPU 50 determines whether the game number T of the bonus game reaches the predetermined number in S51 or not. More specifically, the determination is made depending on whether the game number T stored in the RAM 52 becomes “0” or not. If the game number T is not “0”, that is, it is determined that the number of executing the bonus games does not reach the number determined in S51 (S72: NO), the program returns to S52 and repeats the aforementioned processes. On the other hand, if it is determined that the game number T is “0”, that is, it is determined that the number of executing the bonus games reaches the number determined in S51 (S72: YES), the bonus game process program is terminated.

As shown in FIG. 34, during the game in the bonus game mode, the additional bet lottery is not conducted. When the process as shown in FIG. 34 is executed, the CPU 50 works as inhibit lottery means for precluding the lottery to determine whether to conduct the additional bet or not if the game is in the special game mode (e.g., bonus game mode).

FIGS. 21A and 21B are front views showing images displayed on the lower liquid crystal display. FIG. 21A is a front view showing images displayed on the lower liquid crystal display when the reel bands are displayed in a stationary manner. FIG. 21B is a front view showing images displayed on the lower liquid crystal display after the images shown in FIG. 21A are displayed (e.g., 2 second later).

For example, suppose five “A” symbols are displayed along the pay line L1 in S33 (refer to FIG. 33) as shown in FIG. 21A. If the additional bet lottery (refer to S141 in FIG. 32) is won (by way of example, 3-bet addition is won in FIG. 21B), “3 BETS ADDED!! PAYOUT 3 TIMES!!” (three bets are added and the payout amount is tripled) is displayed on the lower liquid crystal display as shown in FIG. 21B.

As described above, according to the slot machine 1 of the fourth embodiment, during a period of time until the variably-displayed symbols of the plurality of reel bands are displayed in a stationary manner, the lottery to determine whether the additional bet is conducted or not. If it is determined to conduct the additional bet, the payout table is selected according to the lottery result.

Also, in the slot machine 1 of the fourth embodiment, if it is determined to conduct the additional bet, the probability table (probability table B) containing zero percent of winning probability to win the winning combination for converting the game into the special game mode is selected. Therefore, it is sure to prevent the duplicated winnings in a plurality of lotteries at the same time.

Also, in the slot machine 1 of the fourth embodiment, the lottery to determine whether to conduct the additional bet or not is prohibited when the game is played in the bonus game mode. Therefore, the additional bet, which benefits the player furthermore, is not conducted if the game is in the special game mode so as to prevent the extremely advantageous situations to the player such that the gaming center can manage the business. Also, the game in the special mode is a so-called future game which is played without betting the game media such that no lottery for the additional bet is necessary. Therefore, it is possible to alleviate a burden on the slot machine by omitting this lottery process.

In the fourth embodiment, an explanation is made for the case in which two kinds of probability tables are provided to correspond to winning or losing the additional bet. However, for example, the game program may have only one probability table and the probabilities to win the additional bet which are listed in the probability table may be converted by a predetermined formula according to the winning or losing the additional bet.

In the fourth embodiment, an explanation is made for the case in which the probability table containing zero percent of winning probability to win the winning combination for converting the game into the special game mode is selected. The present invention is not limited to this. For example, the program may be controlled so that the bonus game cannot be won if the additional bet is won.

In the fourth embodiment, the explanation is made for the case that the control process is conducted to change the payout amounts in coins in the case of winning according to the additional bet number that has been caused by winning the additional bet lottery. The present invention is not limited to this example, but may include a control process to activate the pay line having not been activated according to the additional bet number.

In the fourth embodiment, an explanation is made for the slot machine in which the additional bet lottery is not conducted during the game in the bonus game mode. However, the present invention is not limited to this embodiment. For example, the slot machine can be configured such that the additional bet lottery is conducted irrespective of the game mode (i.e., in both base game mode and bonus game mode), but it may be configured that the additional bet cannot be won during the game in the bonus game mode.

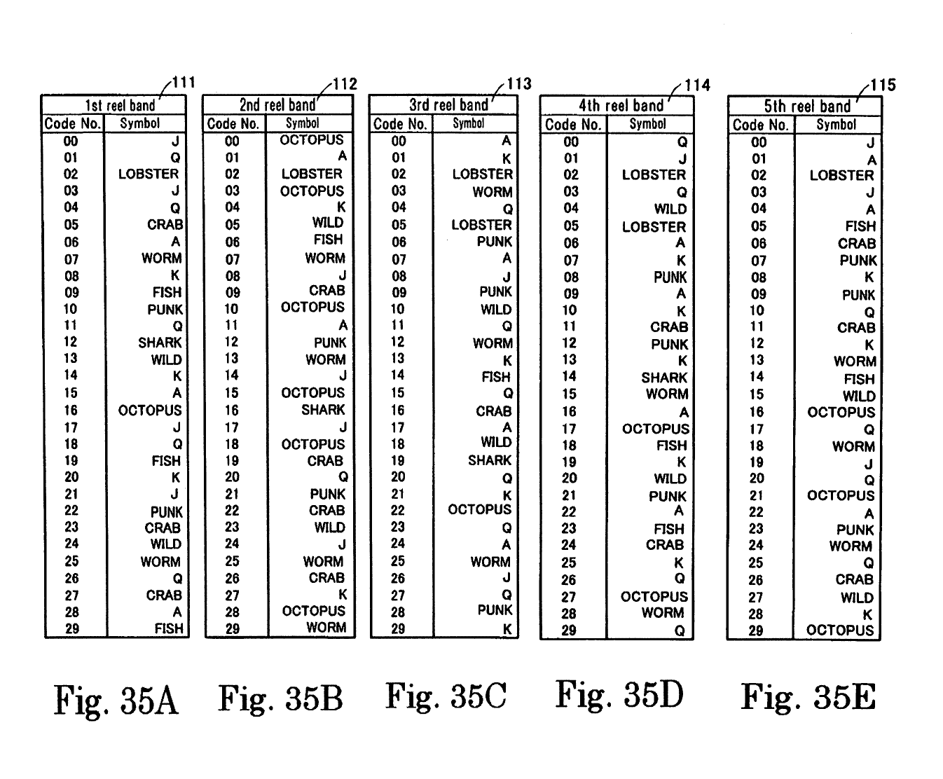

In the fourth embodiment, a lottery for determining the winning combination is conducted to determine symbols that come to a halt and are displayed in a stationary manner. The determination of the displayed symbols is made with the probability table B (refer to FIG. 28B) having zero percent probability of obtaining a predetermined winning combination of a bonus shift trigger in order to inhibit the shift to the game in the bonus mode. However, the present embodiment is not limited to this and may be modified to include a process that each of the displayed symbols is determined by an individual lottery. In such a case, each reel band may have an array of symbols excluding “SARDINE” (refer to FIGS. 35A through 35E) in order to preclude the bonus shift trigger (e.g., “SARDINE×5”).

In the above embodiments, an explanation is made for the slot machine to which the present invention is applied. However, the present invention may also be applied to other gaming machines (for example, pachi-slot gaming machine).

As stated above, the embodiments of the present invention are explained by way of example. And the present invention is not limited to these and each means and concrete configuration thereof can be changed or modified without departing from the scope of the present invention. The described effects of the embodiments of the present invention are examples of preferable effects which may be caused by the present invention. Therefore, the effects of the present invention are not limited to those written with respect to the embodiments.

As described above, in the present invention, there is provided a gaming machine which can provide the player with a big satisfaction as the bet number is directly associated so as to enhance the expectation in the game.

There is provided a gaming machine to which a bet lottery function is added in order to increase the bet number without inserting additional game media. In this gaming machine, the bet number is directly associated with a control process (e.g., a process to change the payout according to a lottery result and a process to increase the number of pay lines according to the lottery result) to be executed according to a lottery result of the bet number such that the player can feel that the control process is executed due to the additional bet, thereby enhancing the expectation and providing the player with a big satisfaction.

However, the bet lottery function is beneficial to the player, and if the bet lottery function is applied to a gaming machine that provides a so-called future game as a bonus game, the player has too much advantage such that the arcade owner may just lose money.

In the present invention, there may be provided a gaming machine which can provide the arcade owner with a stable profit without losing the player's expectation and satisfaction.

According to the present invention, the following examples may be provided.

A gaming machine in which a plurality of symbols are variably displayed is provided. The symbols are stopped and displayed in a stationary manner such that a number of game media corresponding to a winning combination of symbols are paid out to a player when the displayed plurality of symbols include the winning combination among predetermined winning combinations of symbols. The gaming machine comprises: setting means for setting a bet number of game media for a game; variable display means for displaying and stopping the plurality of symbols; lottery means for conducting a lottery to determine whether to allow an additional bet to increase the bet number having been set by the setting means without inserting an additional game medium during a period until the plurality of symbols being variably displayed are stopped and displayed in a stationary manner; and process means for conducting a control process of paying out game media responsive to a lottery result when the lottery means determines to conduct the additional bet.

According to the above described gaming machine, a lottery is conducted to determine whether to perform an additional bet to increase the bet number without inserting any additional game media before the plurality of symbols having being variably displayed are stopped and displayed in a stationary manner. If it is determined to conduct the lottery, a control process is executed to pay out game media according to a lottery result.

In the present invention, the game media to be paid out to the player may include a coin, a medal and the like; and further a storage medium such as a prepaid card that can store data electronically; and further a recordable medium such as a receipt-like piece of paper on which data is printed. The form of the game medium is not limited.

The gaming machine as described above further comprises: payout data storage means for storing a plurality of payout data to determine the corresponding number of game media to be paid out to each winning combination. It is characterized in that the process means selects payout data corresponding to the lottery result by the lottery means from the plurality of payout data being stored by the payout data storage means.

According to the above-described gaming machine, if it is determined to conduct the additional bet, specific payout data is selected among various kinds of payout data. Therefore, it is possible to provide the player with an amusement that the player's expectation can be enhanced because of the payout based on the selected payout data.

In the present invention, the payout data may be the data determining each payout amount of the game media corresponding to each winning combination. The formality of the data is not limited. For example, the payout data may include a table. Also, the payout data is not necessarily a table. For example, if the payout amount of the game media is calculated by a predetermined formula, data to be utilized and referred to is included by the payout data according to the present invention.

The gaming machine as described above further comprises: activation means for activating a number of pay lines corresponding to the bet number having been set by the setting means. The displayed plurality of symbols include the winning combination of symbols along any of the number of pay lines. The process means conducts a control process of activating a pay line having not been activated according to the set bet number as the lottery means determines to conduct the additional bet.

According to the above-described gaming machine, if it is determined to conduct the additional bet, the pay line that has not been activated is activated according to the additional bet. Therefore, it is possible to provide the player with an amusement to watch carefully the pay line activated due to the additional pay line.

The gaming machine as described above is characterized in that the payout data storage means stores max payout data to be selected only when the bet number having been set by the setting means is a max bet number that is an upper limit of settable bet numbers. And the process means selects the max payout data when the max bet number is set by the setting means as the lottery means determines to conduct the additional bet.

According to the above-described gaming machine, if MAX bet number is set, i.e., the game is played with the MAX bets when it is determined to conduct the additional bet, a maximum payout data is selected only with the MAX bet number. Therefore, it can be prevented that the player plays the game only with non-MAX bets.

The gaming machine as described above is characterized in that the process means conducts the control process of activating the pay line only when the bet number having been set by the setting means is a maximum bet number.

The gaming machine as described above further comprises: payout means for paying out game media; and notification means for notifying a lottery result when the lottery means determines to conduct the additional bet. The notification means notifies the lottery result after the plurality of symbols having been variably displayed are stopped and displayed in a stationary manner. The payout means pays out the game media after the notification means notifies the lottery result.

According to the gaming machine as described above, when it is determined to conduct the additional bet, the plurality of symbols being variably displayed are stopped and displayed in a stationary manner. Then, the lottery result is announced. After that, the game media are paid out. Therefore, it is possible to provide the player with joy to find the symbols are stopped in the winning combination and joy to realize the bet number is changed in two steps, thereby enhancing the amusement.

The gaming machine as described above further comprises: special game performance means for carrying out the game in a special game mode in which it is more likely to obtain the winning combination in the displayed plurality of symbols than a base game mode; and inhibit process means for inhibiting the control process while the special game performance means is carrying out the game in the special game mode.

Since the bet lottery to determine whether to conduct the additional bet or not, by way of example, is not executed or the bet lottery cannot be won (or it is forced to lose the bet lottery) when the game is conducted in the special mode (e.g., bonus game mode), a control process about the payout of the game media is executed such that it is prevented the game situations from becoming extremely advantageous to the player to avoid undermining the business extremely in the game center or the arcade.

The gaming machine as described above further comprises: bet lottery table storage means for storing a plurality of additional bet lottery tables to determine whether the additional bet is conducted or not. The inhibit process means selects an additional bet lottery table having zero percent probability of conducting the additional bet while the special game performance means is carrying out the game in the special game mode.

According to the above-described gaming machine, the additional bet lottery table containing zero probability to conduct the additional bet is selected from the plurality of bet lottery tables while the game is played in the special mode.

The gaming machine as described above further comprises: inhibit winning means for inhibiting a predetermined winning combination of symbols to shift the game from in a base game mode to in a special game mode in which more game media are provided than the base game mode when the lottery means determines to conduct the additional bet.

According to the above-described gaming machine, if it is determined to conduct the additional bet, it is prohibited that the plurality of symbols are stopped and displayed in a stationary manner in the winning combination to shift the game into the special game mode (e.g., a future game as a bonus game). Therefore, the additional bet by the bet lottery and the winning combination to shift the game into the special game mode do not occur at the same time such that it is prevented to provide the player with too much advantage. Thus, the game center or the game arcade can have reasonable business. Here, the future game is a game to be played more than once without betting any game media according to the lottery result at the time of shifting to the special game (future game).

The gaming machine as described above further comprise: probability table storage means for storing a plurality of probability tables listing each winning probability for each winning combination. The inhibit winning means selects an probability table having zero percent probability of obtaining the predetermined winning combination.

According to the above-described gaming machine, when it is determined to conduct the additional bet, the probability table containing zero percent of winning probability to obtain the winning combination to shift the game into the special game mode is selected from the plurality of probability tables. Therefore, it is possible to make it sure to avoid the duplicated winnings in the plurality of lotteries.

The gaming machine as described above further comprises: inhibit lottery means for inhibiting the lottery to determine whether to allow the lottery means to conduct the additional bet or not.

According to the above-described gaming machine, the lottery to determine whether to conduct the additional bet or not is prohibited when the game is in the special game mode. Therefore, during the game in the special game mode advantageous to the player, the additional bet to make the situation more advantageous to the player is not conducted such that the situation extremely advantageous to the player is prevented and the game center or the game arcade can have reasonable business. And if the special game is the future game, which can be conducted without betting any game media, it is not necessary to conduct the lottery so as to alleviate the burden on the gaming machine by omitting the lottery process.

The gaming machine as described above further comprises: notification means for notifying the lottery result when the lottery means determines to conduct the additional bet.

According to the above-described gaming machine, if it is determined to conduct the additional bet, the lottery result is announced in voice from the speaker and visually on the display. Therefore, it is possible to provide the player with feeling of benefiting.

The gaming machine as described above is characterized in that the process means conducts the control process of the game media payout corresponding to the lottery result when the lottery means determines to conduct the additional bet.

According to the above-described gaming machine, if it is determined to conduct the additional bet, the number of game media in accordance with the lottery result (for example, as many as the number of additional bets) are paid out. Therefore, it is possible to provide the player with an amusement that the player may obtain a special benefit caused by something other than the stationary display combination of the reels.

What is claimed is:

1. A gaming machine comprising:
a bet input device for setting a bet number to start a game;
a display device for displaying variably a plurality of symbols, wherein the plurality of symbols come to a halt and are displayed in a stationary manner on the display device such that a value corresponding to a winning combination and the bet number is paid out when the winning combination is included in the displayed plurality of symbols; and
a payout device for paying out the value,
wherein it is determined to increase the bet number based on a lottery result of an additional bet lottery being conducted during a period until the plurality of symbols come to a halt; and
wherein the payout device pays out the value corresponding to the winning combination and the increased bet number.

2. The gaming machine according to claim 1, comprising:
a memory for storing a plurality of kinds of payout data that determine each value to be paid out corresponding to each winning combination,
wherein a kind of payout data is selected from the plurality of kinds of payout data when it is determined to increase the bet number based on the lottery result.

3. The gaming machine according to claim 1, comprising:
a pay-line input device for setting a number of pay lines,
wherein a predetermined number of pay lines are activated based on the set number of pay lines;
wherein a pay line having not been activated may be activated when it is determined to increase the bet number based on the lottery result; and
wherein the winning combination is formed along any of a total number of activated pay lines.

4. The gaming machine according to claim 12,
wherein the memory stores maximum payout data to be utilized when the set bet number is a maximum value that can be set by the bet input device; and
wherein the maximum payout data is selected when it is determined to increase the bet number based on the lottery result.

5. The gaming machine according to claim 13,
wherein the pay line, to be activated when the set bet number is a maximum value that the bet input device can set and it is determined to increase the bet number based on the lottery result, is activated.

6. The gaming machine according to claim 13,
wherein the pay line, not to be activated based on the set number of pay lines, is activated when it is determined to increase the bet number based on the lottery result.

7. The gaming machine according to claim 6,
wherein the pay line is activated only when the set bet number is a maximum value that the bet input device can set.

8. The gaming machine according to claim 4, comprising:
a notification device for notifying the lottery result causing the bet number to be increased after the plurality of symbols come to a halt and are displayed in a stationary manner,
wherein the payout device pays out the value after the lottery result is notified.

9. The gaming machine according to claim 1,
wherein the game is carried out in either a base game mode or a special game mode in which it is more likely to obtain the winning combination than the base game mode; and
wherein the lottery result of the additional bet lottery precludes a possibility of increasing the bet number when the game is carried out in the special game mode.

10. The gaming machine according to claim 9, comprising:
a memory for storing a plurality of kinds of additional bet lottery tables to determine whether to increase the bet number or not,
wherein an additional bet lottery table having zero percent probability of increasing the bet number is selected when the game is carried out in the special game mode.

11. The gaming machine according to claim 1,
wherein the plurality of symbols displayed in a stationary manner are precluded from including a predetermined winning combination as a shift condition for shifting a game operation from a base mode to a special mode, in which a higher value may be paid out than the base mode, when it is determined to increase the bet number based on the lottery result.

12. The gaming machine according to claim 11, comprising:
a memory for storing a plurality of kinds of probability tables to list each winning probability for each winning combination,
wherein a probability table having zero percent probability of obtaining the predetermined winning combination is selected when it is determined to increase the bet number based on the lottery result.

13. The gaming machine according to claim 11,
wherein the additional bet lottery is precluded when the game is carried out in the special game mode.

14. The gaming machine according to claim 1, comprising:
a notification device for notifying the lottery result causing the bet number to be increased when it is determined to increase the bet number.

15. The gaming machine according to claim 1,
wherein the payout device pays out the value, when it is determined to increase the bet number, corresponding to the winning combination and the increased bet number.

16. The gaming machine according to claim 1,
wherein the game is carried out in either a base game mode or a special game mode, in which a probability of obtaining the winning combination is higher or more game media may be paid out per one game than the base game mode; and
wherein the lottery result of the additional bet lottery precludes a possibility of increasing the bet number when the game is carried out in the special game mode.
